(19) United States
(12) Patent Application Publication
(10) Pub. No.: US 2017/0230871 A1
(43) Pub. Date: Aug. 10, 2017

(54) Cellular Wireless Access Data Offload System

(71) Applicant: Sooktha Consulting Private Limited, Bangalore (IN)

(72) Inventors: Balaji Rangaswamy, Bangalore (IN); Srinivasan Radhakrishnan, Bangalore (IN); Rahul Vatsa, Bangalore (IN)

(73) Assignee: Sooktha Consulting Private Limited

(21) Appl. No.: 15/092,635

(22) Filed: Apr. 7, 2016

(30) Foreign Application Priority Data
Feb. 4, 2016 (IN) 201641003991

(51) Int. Cl. H04W 36/00; H04W 36/30; H04L 12/46; H04W 72/04; H04L 29/12

(52) U.S. Cl. CPC H04W 36/0022; H04W 72/0406; H04L 61/2007; H04L 12/4633; H04W 36/30

(57) ABSTRACT

A method and a cellular wireless access data offload system (CWADOS) implemented in a base station of a cellular wireless communication network, for offloading data from a first cellular wireless communication interface (FCWCI) to a second wireless communication interface (SWCI) without impacting cellular wireless protocols of the cellular wireless communication network are provided. The CWADOS transmits wireless connection identification information to a user device for establishing the SWCI between the user device and a wireless access point, determines the FCWCI or the SWCI for transmitting downlink data packets from a core network to the user device and for transmitting uplink data packets from the user device to the core network based on switching criteria, forwards the downlink data packets to the user device via the FCWCI or the SWCI, and forwards the uplink data packets received from the user device via the FCWCI or the SWCI to the core network.

### CROSS-REFERENCE TO RELATED APPLICATIONS

This application claims priority to and the benefit of the non-provisional patent application number 201641003991 titled “Cellular Wireless Access Data Offload System”, filed in the Indian Patent Office on Feb. 4, 2016. The specification of the above referenced patent application is incorporated herein by reference in its entirety.

### BACKGROUND

With the growing use of smartphones and access to the World Wide Web using a cellular wireless communication network, there is a significant increase in mobile data traffic. Data usage on a limited amount of a licensed spectrum through smartphones has also increased, resulting in wireless network congestion in the licensed spectrum. Moreover, an increased use of high bandwidth and high speed applications, for example, audio and video streaming, gaming, etc., is increasing the data usage beyond the capability of the available licensed spectrum. A radio frequency spectrum is a scarce and expensive resource for cellular network operators. A long term evolution (LTE) advanced technology, for example, an advanced fourth generation (4G) mobile telecommunications technology achieves a maximum spectral efficiency among existing mobile telecommunications technologies. However, to cater to the increasing data usage, further technological developments and enhancements in the architecture of the cellular wireless communication network are bound by physical limitations and are not economically viable. Therefore, to handle the mobile data traffic explosion, cellular network operators are considering offloading some or all of the mobile data from the licensed spectrum to the unlicensed spectrum.

Of the available technologies to offload mobile data, an interface of a wireless network that implements Wi-Fi® of Wi-Fi Alliance Corporation, herein referred to as the “Wi-Fi network”, is the choice for offloading mobile data. The interface of the Wi-Fi network, herein referred to as the “Wi-Fi interface”, operates on the unlicensed spectrum and does not exploit the licensed spectrum. Moreover, since the amount of the unlicensed spectrum is substantially greater than the licensed spectrum, the Wi-Fi interface can handle more mobile data traffic than an interface of the cellular wireless communication network, that is, a wireless wide area network (WWAN) interface, for example, a long term evolution (LTE) interface. Another reason for choosing Wi-Fi technology over other small cell technologies is the ubiquity of the Wi-Fi network. Since the Wi-Fi network infrastructure is already deployed in multiple locations, for example, households, enterprises, retail establishments, public places, etc., there is a need for only a software upgrade to existing systems for offloading mobile data using the Wi-Fi network. Multiple user devices being Wi-Fi network enabled and widespread use of these user devices to access the internet favor the Wi-Fi network for offloading mobile data. The Wi-Fi network solution is therefore cost effective and easy to deploy and employ for offloading mobile data.

In a typical cellular wireless communication network setup, user devices communicate with core network elements of the cellular wireless communication network via a radio base station to access the internet and intranet for data. Activities comprising, for example, bulk file transfers, electronic mail (email) communication, video calls, high definition video downloading, continuous uploading of data to the internet, etc., are typically performed over the Wi-Fi network. Mobile data is transmitted and received in the form of data packets in the cellular wireless communication network. With the increase in mobile data traffic in the cellular wireless communication network, the mobile data is offloaded to the Wi-Fi interface between the user devices and an access point of the Wi-Fi network.

There is a need to address multiple aspects to enhance the implementation of offloading mobile data from a cellular wireless communication interface, for example, the long term evolution (LTE) interface, to the Wi-Fi interface in a cellular wireless communication network. One of the aspects is to increase the number of Wi-Fi networks for easy access to offload the mobile data. For increasing the Wi-Fi networks, cellular service providers have the choice between developing a new infrastructure to offload the mobile data and forming a mutual agreement with available wireless internet service providers to use a deployed Wi-Fi network. The second aspect is to ensure there is seamless switching between the cellular wireless communication network and the Wi-Fi network with minimal or no user interaction with the cellular wireless communication network to offload the mobile data. Another requirement for enhancing the implementation of offloading the mobile data to the Wi-Fi network is to have an authentication mechanism acceptable for both the cellular wireless communication network and the Wi-Fi network. Seamless mobility while the user is roaming from one cellular wireless communication network to another cellular wireless communication network also has to be addressed for implementing the offloading of the mobile data from the cellular wireless communication interface to the Wi-Fi interface.

Although multiple mechanisms for implementing the offloading of the mobile data from the cellular wireless communication interface to the Wi-Fi interface are devised, these mechanisms pose numerous challenges. One of the conventional mechanisms to offload the mobile data from the cellular wireless communication network to trusted wireless access points or untrusted wireless access points of the Wi-Fi network needs changes to the core network elements and additional elements in the cellular wireless communication network. For example, offloading the mobile data to trusted wireless access points or untrusted wireless access points of the Wi-Fi network requires changes to a packet data network (PDN) gateway in the long term evolution (LTE) network, changes to an S2a Mobility over GTP (SaMoG) gateway for trusted wireless access points, where GTP refers to a general packet radio service (GPRS) tunneling protocol, and changes to an evolved packet data gateway (ePDG) for untrusted wireless access points. Another mechanism to offload the mobile data from the cellular wireless communication network to the Wi-Fi network aggregates the cellular wireless communication network and the Wi-Fi network by aggregating a bearer of the cellular wireless communication interface with a bearer of the Wi-Fi interface. This mechanism requires changes to a signalling and data protocol stack of a user device and a signalling and data protocol stack of the base station, and further requires support for carrier aggregation.

Moreover, in conventional cellular wireless communication networks for offloading mobile data from the cellular wireless communication interface to the Wi-Fi interface, the mobile data is routed via the Wi-Fi network without performing a deep packet inspection of the mobile data based on the quality of service (QoS) desired. There is a need for prioritizing the mobile data based on the QoS desired and routing the mobile data accordingly. There is also a need for performing a deep packet inspection of the mobile data to improve user experience and allow cellular service providers to utilize statistical data collected from the deep packet inspection for business analytics. In conventional cellular wireless communication networks, switching between the cellular wireless communication interface and the Wi-Fi interface to offload mobile data is triggered by the user device instead of the cellular wireless communication network elements though the cellular wireless communication network elements have better knowledge about the condition of the cellular wireless communication network. Routing the mobile data over the Wi-Fi interface can cause congestion, as the user device is unaware of mobile data traffic conditions of the Wi-Fi interface. This will result in a bad user experience in streaming related applications. To improve the user experience, there is a need for a switching unit in the cellular wireless communication network to interact with the cellular wireless communication interface and the Wi-Fi interface and initiate the offloading of the mobile data based on flexible and efficient policies.

Furthermore, there is also a need to avoid changes to the cellular wireless communication network and the cellular wireless communication network elements to preclude cellular service providers from incurring additional costs of installation, operation, and maintenance. Changes in the cellular wireless communication network and the cellular wireless communication network elements also induce latency in the cellular wireless communication network, which causes the switching between the cellular wireless communication interface and the Wi-Fi interface to no longer be seamless.

Hence, there is a long felt but unresolved need for a method and a system for offloading data from a cellular wireless communication interface to a Wi-Fi interface without impacting cellular wireless protocols of the cellular wireless communication network. Moreover, there is a need for a method and a system for switching between the cellular wireless communication interface and the Wi-Fi interface based on switching criteria and a communication protocol to avoid latency and provide seamless switching. Furthermore, there is a need for a method and a system for offloading data from the cellular wireless communication interface to the Wi-Fi interface by performing a deep packet inspection on the data and forwarding the data to a destination based on traffic flow identifiers of the data to meet the desired quality of service (QoS) requirements of the data.

### SUMMARY OF THE INVENTION

This summary is provided to introduce a selection of concepts in a simplified form that are further disclosed in the detailed description of the invention. This summary is not intended to determine the scope of the claimed subject matter.

The method and system disclosed herein addresses the above mentioned need for offloading data from a first cellular wireless communication interface to a second wireless communication interface, without impacting cellular wireless protocols of a cellular wireless communication network. The first cellular wireless communication interface is a wireless wide area network (WWAN) interface of the cellular wireless communication network that implements, for example, a long term evolution (LTE) technology, and is herein referred to as the “LTE interface”. The second wireless communication interface is a wireless local area network (WLAN) interface that implements, for example, Wi-Fi® of Wi-Fi Alliance Corporation, and is herein referred to as the “Wi-Fi interface”. Moreover, the method and system disclosed herein performs switching between the LTE interface and the Wi-Fi interface based on switching criteria and a communication protocol to avoid latency and provide seamless switching. Furthermore, the method and system disclosed herein for performing a deep packet inspection on the data and forwarding the data to a destination based on traffic flow identifiers of the data to ensure delivery of the desired quality of service to the data.

The method disclosed herein employs a cellular wireless access data offload system (CWADOS) implemented in a base station of the cellular wireless communication network for offloading data from the long term evolution (LTE) interface to the Wi-Fi interface without impacting cellular wireless protocols of the cellular wireless communication network. The CWADOS transmits wireless connection identification information to a user device on a bearer of the LTE interface using a communication protocol, for example, a user datagram protocol (UDP), a transmission control protocol (TCP), or an internet protocol (IP), for establishing the Wi-Fi interface between the user device and a wireless access point. The CWADOS determines the LTE interface or the established Wi-Fi interface for transmitting downlink data packets from a core network of the cellular wireless communication network to the user device and for transmitting uplink data packets from the user device to the core network, based on switching criteria.

The cellular wireless access data offload system (CWADOS) forwards the downlink data packets received from the core network on a cellular wireless network interface to the user device via the long term evolution (LTE) interface or the Wi-Fi interface. The cellular wireless network interface is, for example, a user plane of an S1 interface, herein referred to as the “S1-U interface”. The CWADOS forwards the uplink data packets received from the user device via the LTE interface or the Wi-Fi interface to the core network on the S1-U interface. In the method disclosed herein, offloading of data is achieved in the base station and this maintains the core network architecture and allows a reuse of the S1 interface, while not requiring an aggregation of the LTE interface and the Wi-Fi interface. The CWADOS also performs a deep packet inspection of the uplink data packets to create a mapping of traffic flow identifiers to corresponding bearers on the S1-U interface. The CWADOS performs the deep packet inspection to obtain packet forwarding information from the uplink data packets and maps uplink data packets to the corresponding bearers on the S1-U interface using the traffic flow identifiers. In the method disclosed herein, the offloading of data is achieved without changing the core network and a protocol stack of the base station.

In one or more embodiments, related systems comprise circuitry and/or programming for effecting the methods disclosed herein; the circuitry and/or programming can be any combination of hardware, software, and/or firmware configured to effect the methods disclosed herein depending upon the design choices of a system designer. Also, various structural elements can be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 illustrates a method for offloading data from a first cellular wireless communication interface to a second wireless communication interface without impacting cellular wireless protocols of a cellular wireless communication network.

FIG. 2 exemplarily illustrates a message flow diagram showing communication between an offload agent deployed on a user device and a cellular wireless access data offload system implemented in a base station for forwarding downlink data packets and for switching between the first cellular wireless communication interface and the second wireless communication interface for forwarding uplink data packets.

FIGS. 3A-3B exemplarily illustrate a flowchart comprising steps for offloading downlink data packets from the first cellular wireless communication interface to the second wireless communication interface.

FIG. 4 exemplarily illustrates a flowchart comprising steps of a method for establishing a connection between the user device and a wireless access point and forwarding downlink data packets on the second wireless communication interface to the user device.

FIG. 5 exemplarily illustrates a flowchart comprising steps of an embodiment of the method for establishing a connection between the user device and a wireless access point and forwarding downlink data packets on the second wireless communication interface to the user device.

FIG. 6 exemplarily illustrates a flowchart comprising steps of another embodiment of the method for establishing a connection between the user device and the wireless access point and forwarding the downlink data packets on the second wireless communication interface to the user device.

FIG. 7 exemplarily illustrates a flowchart comprising steps of a method for switching between the first cellular wireless communication interface and the second wireless communication interface and forwarding uplink data packets to a core network on a cellular wireless network interface.

FIG. 8 exemplarily illustrates a flowchart comprising steps of an embodiment of the method for switching between the first cellular wireless communication interface and the second wireless communication interface and forwarding uplink data packets to the core network on the cellular wireless network interface.

FIG. 9 exemplarily illustrates a flowchart comprising steps of another embodiment for switching between the first cellular wireless communication interface and the second wireless communication interface and forwarding uplink data packets to the core network on the cellular wireless network interface.

FIG. 10 exemplarily illustrates a communications system for offloading data from the first cellular wireless communication interface to the second wireless communication interface without impacting cellular wireless protocols of the cellular wireless communication network.

FIG. 11 exemplarily illustrates a block diagram of the base station comprising the cellular wireless access data offload system for offloading data from the first cellular wireless communication interface to the second wireless communication interface without impacting cellular wireless protocols of the cellular wireless communication network.

### DETAILED DESCRIPTION OF THE INVENTION

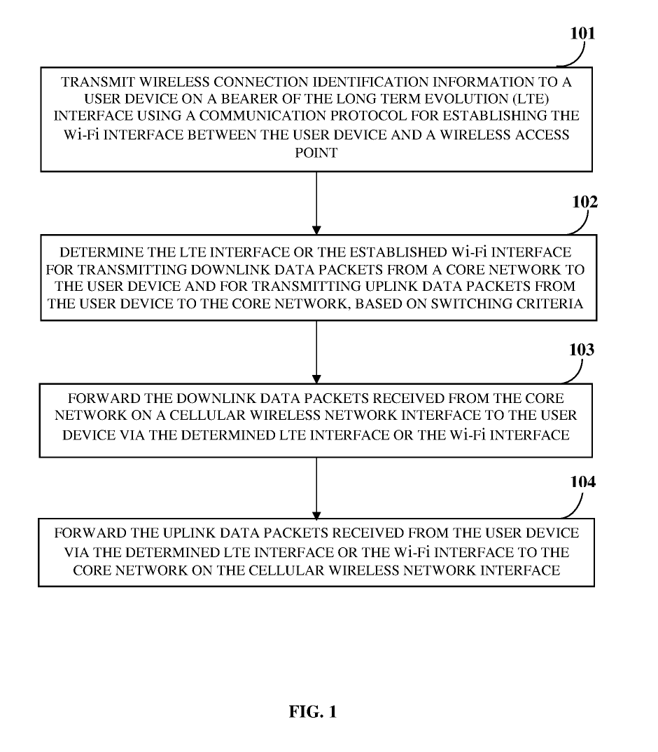

FIG. 1 illustrates a method for offloading data from a first cellular wireless communication interface to a second wireless communication interface without impacting cellular wireless protocols of a cellular wireless communication network. As used herein, “offloading” comprising, for example, mobile data offloading or Wi-Fi offloading refers to the use of complementary network technologies, for example, Wi-Fi® of Wi-Fi Alliance Corporation, for delivering data targeted for cellular networks. Also, as used herein, “data” refers to information that is generated, stored, or transmitted in a digital format by a processor capable of executing computer program instructions for processing the information. The data is, for example, mobile data comprising audio data, video data, games, images, applications from the internet on a mobile device, etc. Also, as used herein, “first cellular wireless communication interface” refers to a wireless wide area network (WWAN) interface of the cellular wireless communication network between a user device and a base station of the cellular wireless communication network. Also, as used herein, “cellular wireless communication network” refers to a telecommunications network that uses wireless data connections for connecting network nodes and enabling telecommunications between the network nodes. The cellular wireless communication network implements, for example, a long term evolution (LTE) technology, and for purposes of illustration, is hereinafter referred to as an “LTE network”, and accordingly the first cellular wireless communication interface is hereinafter referred to as an “LTE interface”. LTE is a wireless communication technology that supports high speed data for user devices, for example, mobile devices, smartphones, etc. Also, as used herein, the “second wireless communication interface” refers to a wireless local area network interface (WLAN) that implements, for example, Wi-Fi® of Wi-Fi Alliance Corporation, and for purposes of illustration, is hereinafter referred to as a “Wi-Fi interface”. Also, as used herein, “cellular wireless protocols” refers to protocols used for communication between the user device and the base station of the LTE network.

For purposes of illustration, the detailed description refers to the first cellular wireless communication interface, the second wireless communication interface, and the cellular wireless communication network as the long term evolution (LTE) interface, the Wi-Fi interface, and the LTE network respectively; however the scope of the method and the system disclosed herein is not limited to the first cellular wireless communication interface, the second wireless communication interface, and the cellular wireless communication network being the LTE interface, the Wi-Fi interface, and the LTE network respectively, but may be extended to include other wireless wide area network (WWAN) interfaces, wireless local area network interface (WLAN) interfaces, and cellular wireless communication networks respectively.

The method disclosed herein employs a cellular wireless access data offload system (CWADOS) implemented in the base station of the long term evolution (LTE) network for offloading data from the LTE interface to the Wi-Fi interface, without impacting the cellular wireless protocols of the LTE network, for example, by not impacting core network elements and LTE protocol stacks. In the LTE network, user devices communicate with a core network of the LTE network via multiple radio base stations to access the internet and intranet for data. The CWADOS is implemented in each of the radio base stations of the LTE network. The base station is, for example, an evolved Node B (eNodeB) in the LTE network.

The cellular wireless access data offload system (CWADOS) transmits 101 wireless connection identification information to the user device, on a bearer of the long term evolution (LTE) interface using a communication protocol for establishing the Wi-Fi interface between the user device and a wireless access point. As used herein, “wireless access point” refers to a networking hardware device that allows wireless connections and routing of data between the base station and the user device. The wireless access point implements, for example, Wi-Fi® of Wi-Fi Alliance Corporation, and allows Wi-Fi connections and routing of data between the base station and the user device. In an embodiment, the CWADOS configures the wireless access point to forward uplink data packets received by the wireless access point to the base station through multiple different methods. As used herein, “data packets” refer to data in the LTE network that is received and transmitted in the form of packets. Also, as used herein, “uplink data packets” refer to data packets moving from the user device towards the data network via the base station. In an example of one of the methods for forwarding uplink data packets, the CWADOS configures the base station to be a default gateway for the wireless access point and requests the wireless access point to forward the uplink data packets received by the wireless access point to the base station. Also, as used herein, “communication protocol” refers to a protocol for communication over the LTE network. The communication protocol is, for example, a user datagram protocol (UDP), or a transmission control protocol (TCP), or an internet protocol (IP). As used herein, references to IP comprise a fourth version and a sixth version of the IP. Also, as used herein, “bearer”, also referred as a “logical bearer”, refers to a carrier of data packets in the LTE network. A different bearer is used to transmit data packets over different interfaces of the LTE network. A bearer for a data network connection in the LTE network is, for example, an evolved radio access bearer. A data network connection in the LTE network is referred to as a “packet data network (PDN) connection”. The PDN connection comprises one or more bearers. A bearer on the LTE interface is, for example, a data radio bearer. An LTE PDN connection has at least one data radio bearer referred to as a “default radio bearer”, and in an embodiment, has additional data radio bearers referred to as “dedicated bearers”. Each bearer in a data network has a corresponding bearer on the LTE interface. That is, a data radio bearer of the LTE interface has a corresponding evolved radio access bearer. Each bearer does not have a corresponding bearer on the Wi-Fi interface. A bearer comprises one or more traffic flows that are unidirectional or bidirectional. As used herein, “traffic flow”, also referred to as a “service flow”, refers to a sequence or flow of data packets from a source to a destination.

The cellular wireless access data offload system (CWADOS) transmits the wireless connection identification information to the user device on a default bearer of the long term evolution (LTE) interface or a dedicated bearer of the LTE interface and carries the wireless connection information over the communication protocol, for example, the transmission control protocol (TCP) or the user datagram protocol (UDP), on a reserved port number for the TCP or the UDP, or on a reserved protocol number for the internet protocol (IP). The wireless connection identification information comprises, for example, a unique identifier of the wireless access point such as a service set identifier (SSID), and authentication information comprising, for example, pass phrases, passwords, keys, etc., required for the user device to establish a connection with the wireless access point.

The cellular wireless access data offload system (CWADOS) transmits the wireless connection identification information to the user device when the user device establishes one or more packet data network connections in the long term evolution (LTE) network and when the LTE interface for each of the established packet data network connections is activated. The CWADOS transmits the wireless connection identification information to the user device based on one or more network addresses associated with the LTE interface and/or the Wi-Fi interface and received from the user device by the CWADOS. In an embodiment, the CWADOS transmits the wireless connection identification information to the user device on receiving an internet protocol (IP) address allocated for each of the activated packet data network connections, herein referred to as the “packet data network connection IP address”, and a physical address of the user device, for example, a Wi-Fi media access control (Wi-Fi MAC) address, from the user device. The CWADOS requests the user device to connect to the wireless access point and assign the packet data network connection IP address as a static IP address to the Wi-Fi interface or acquire the IP address of the Wi-Fi interface from the wireless access point. The CWADOS further requests the user device to confirm completion of the above actions. As part of these requests, the CWADOS transmits the wireless connection identification information to enable the user device to establish a connection to the wireless access point.

In an embodiment, the cellular wireless access data offload system (CWADOS) receives a network address, for example, an internet protocol (IP) address of the Wi-Fi interface assigned to the user device by the wireless access point, after transmitting the wireless connection identification information to the user device. In another embodiment, the CWADOS receives a network address, for example, an IP address of the Wi-Fi interface assigned to the user device by the wireless access point and a network address, for example, a packet data network connection IP address of the long term evolution (LTE) interface, after transmitting the wireless connection identification information to the user device.

The cellular wireless access data offload system (CWADOS) determines 102 the long term evolution (LTE) interface or the Wi-Fi interface for transmitting downlink data packets from a core network of the LTE network to the user device and for transmitting uplink data packets from the user device to the core network, based on switching criteria. As used herein, “downlink data packets” refer to data packets moving from the core network to the user device via the base station. The CWADOS switches the uplink data packets and the downlink data packets between the LTE interface and the Wi-Fi interface based on the switching criteria. The switching criteria for transmitting the downlink data packets from the core network to the user device and for transmitting the uplink data packets from the user device to the core network comprise, for example, one or more of loading of the base station, a load on the Wi-Fi interface, quality of service (QoS) requirements of bearers of the LTE interface such as data radio bearers, channel conditions of the LTE interface, channel conditions of the Wi-Fi interface, a control policy of the LTE network, etc. The loading of the base station is, for example, determined by a percentage of a capacity of a general purpose processing unit of the base station or capacity that is already used. The load on the Wi-Fi interface is, for example, determined by a data rate that is being served by the Wi-Fi interface. The QoS requirements of the bearers of the LTE interface comprise, for example, a guaranteed bit rate. The channel conditions of the LTE interface are, for example, determined from measurements of a signal-to-interference-plus-noise ratio on the LTE interface. The channel conditions of the Wi-Fi interface are, for example, determined from measurements of a signal-to-interference-plus-noise ratio on the Wi-Fi interface. The control policy of the LTE network defines, for example, that bearers with a particular set of QoS requirements are always offloaded to the Wi-Fi interface. In an embodiment, the determination of the LTE interface or the Wi-Fi interface for transmitting downlink data packets from the core network of the LTE network to the user device and for transmitting uplink data packets from the user device to the core network is controlled by a policy communicated from the core network.

The cellular wireless access data offload system (CWADOS) dynamically selects the wireless access point for dynamically switching data between the long term evolution (LTE) interface and the Wi-Fi interface based on selection criteria and measurements computed by the user device on request by the base station over the communication protocol. The selection criteria comprise load on the wireless access point, for example, a data rate being served by the wireless access point. The measurements computed by the user device on request by the base station over the communication protocol comprise, for example, a received signal strength indicator for the Wi-Fi interface, number of missed beacons, signal-to-interference-plus-noise ratio, and a frame error rate on the Wi-Fi interface.

The cellular wireless access data offload system (CWADOS) forwards 103 the downlink data packets received from the core network on a cellular wireless network interface to the user device via the long term evolution (LTE) interface or the Wi-Fi interface. As used herein, “cellular wireless network interface” refers to an interface between the base station and the core network, for example, a “user plane of an S1 interface”, also referred to as an “S1-U interface”. A bearer on the S1-U interface is referred to as an “S1-U bearer”. An S1-U bearer has a corresponding evolved radio access bearer of a packet data network connection of the LTE network. To forward the downlink data packets to the user device from the core network via the LTE interface, the CWADOS maps each of the downlink data packets to a corresponding data radio bearer on the LTE interface and forwards the mapped downlink data packets on the corresponding data radio bearer of the LTE interface.

To forward the downlink data packets from the core network to the user device via the Wi-Fi interface, the cellular wireless access data offload system (CWADOS) configures the wireless access point to assign the network address associated with the LTE interface, that is, the received internet protocol (IP) address of the packet data network (PDN) connection as a static IP address to the media access control (MAC) address of the user device on the Wi-Fi interface, that is, to the Wi-Fi MAC address of the Wi-Fi interface. The CWADOS configures the wireless access point prior to forwarding the first downlink data packet on the Wi-Fi interface. On configuring the wireless access point, the CWADOS forwards the downlink data packets received from the core network to the user device via the configured wireless access point on the Wi-Fi interface. That is, the CWADOS forwards the downlink data packets to the configured wireless access point. The configured wireless access point then forwards the downlink data packets to the user device on the Wi-Fi interface. A destination IP address of each of the downlink data packets is the PDN connection IP address. The wireless access point has already been configured with the Wi-Fi MAC address of the user device for this IP address. Therefore, the CWADOS forwards the downlink data packets to the user device automatically.

In an embodiment of forwarding the downlink data packets from the core network to the user device via the Wi-Fi interface, the cellular wireless access data offload system (CWADOS) encapsulates each of the downlink data packets, herein referred to as an “inner internet protocol (IP) data packet”, within an outer data packet, herein referred to as an “outer IP data packet”. A source internet protocol (IP) address of the outer IP data packet is the IP address of the base station. A destination IP address of the outer IP data packet is an address assigned to the user device by the wireless access point. The CWADOS forwards the encapsulated downlink data packets to the user device via the wireless access point on the Wi-Fi interface. That is, the CWADOS forwards each outer IP data packet encapsulating each inner IP data packet, herein referred to as “encapsulated downlink data packets”, to the wireless access point, and the wireless access point forwards the encapsulated downlink data packets to the user device. A wireless local area network (WLAN) driver on the user device receives the encapsulated downlink data packets from the Wi-Fi interface and forwards the encapsulated downlink data packets to a software module, for example, a networking stack on the user device. The networking stack on the user device extracts each inner IP data packet encapsulated within each outer IP data packet and forwards each extracted inner IP data packet to an application on the user device. In another embodiment of forwarding the downlink data packets from the core network to the user device via the Wi-Fi interface, the CWADOS updates a destination IP address of each of the downlink data packets to the IP address of the Wi-Fi interface assigned to the user device by the wireless access point. The CWADOS forwards each of the downlink data packets with the updated destination IP address to the user device via the wireless access point on the Wi-Fi interface. A software module, for example, a networking stack on the user device restores the destination IP address of each of the downlink data packets back to the packet data network connection IP address of the long term evolution (LTE) interface.

The cellular wireless access data offload system (CWADOS) also forwards 104 the uplink data packets received from the user device via the determined long term evolution (LTE) interface or the Wi-Fi interface to the core network on the cellular wireless network interface, for example, the “user plane of an S1 interface”, hereinafter referred to as the “S1-U interface”. An application on the user device sends the uplink data packets to the base station on bearers of the LTE interface, for example, specific LTE data radio bearers. The CWADOS receives the uplink data packets from the user device on bearers of the LTE interface and determines bearers on the S1-U interface that correspond to the bearers of the LTE interface on which the uplink data packets are received. The CWADOS then performs a deep packet inspection of the received uplink data packets, associates traffic flow identifiers of uplink traffic flows of the received uplink data packets to the determined bearers on the S1-U interface, and forwards the received uplink data packets to the core network on the determined bearers on the S1-U interface. As used herein, “traffic flow identifier” refers to a set of elements that are a subset of headers of a list of protocols comprising, for example, the transmission control protocol (TCP), the user datagram protocol (UDP), the internet protocol (IP), an encapsulating security payload (ESP), a hypertext transfer protocol (HTTP), an application protocol, etc., that constitute a data packet. For example, a traffic flow in one direction is identified by a source IP address, a destination IP address, a source UDP port, and a destination UDP port. The traffic flow identifier corresponds to a packet filter within a traffic flow template (TFT) in the LTE network. Also, as used herein, “uplink traffic flow” refers a flow of uplink data packets from the user device to the core network.

To forward the uplink data packets received from the user device via the established Wi-Fi interface to the core network on the S1-U interface, the cellular wireless access data offload system (CWADOS) transmits packet forwarding information for the uplink data packets to be forwarded via the established Wi-Fi interface to the user device. The packet forwarding information comprises, for example, traffic flow identifiers for uplink traffic flows and a corresponding quality of service (QoS) class for each of the uplink traffic flows. The CWADOS receives the uplink data packets from the user device based on the transmitted packet forwarding information via the wireless access point. The CWADOS performs a deep packet inspection of the received uplink data packets and maps traffic flow identifiers of uplink traffic flows of the received uplink data packets to corresponding bearers of the S1-U interface based on an association created between the traffic flow identifiers of the uplink traffic flows of previous uplink data packets received on the long term evolution (LTE) interface and corresponding bearers on the S1-U interface. Based on the mapping of the traffic flow identifiers, the CWADOS forwards the uplink data packets to the core network on the corresponding bearers of the S1-U interface.

In the above method for forwarding the uplink data packets received from the user device via the established Wi-Fi interface to the core network on the S1-U interface, the cellular wireless access data offload system (CWADOS) requests an offload agent on the user device to forward the uplink data packets on the Wi-Fi interface. The CWADOS specifies the traffic flow identifiers of the uplink traffic flows to be forwarded and the corresponding quality of service (QoS) class. The offload agent configures the networking stack on the user device accordingly. The application on the user device sends the uplink data packets to the networking stack. The networking stack checks whether the traffic flow identifiers of the uplink traffic flows of the uplink data packets are among the traffic flow identifiers of the uplink traffic flows requested to be sent on the Wi-Fi interface. If the traffic flow identifiers of the uplink traffic flows of the uplink data packets are among the traffic flow identifiers of the uplink traffic flows requested to be sent on the Wi-Fi interface, then the networking stack forwards the uplink data packets to the wireless access point on the Wi-Fi interface.

In an embodiment of forwarding the uplink data packets received from the user device via the established Wi-Fi interface to the core network on the S1-U interface, the cellular wireless access data offload system (CWADOS) transmits the packet forwarding information for the uplink data packets to be forwarded via the established Wi-Fi interface, to the user device. In this embodiment, the packet forwarding information comprises, for example, traffic flow identifiers for uplink traffic flows, a corresponding quality of service class for each of the uplink traffic flows, and the internet protocol (IP) address of the base station. The uplink data packets are encapsulated within outer internet protocol (IP) data packets on the user device, where each outer IP data packet comprises a source network address, that is, the IP address assigned to the user device by the wireless access point, and a destination network address, that is, the IP address of the base station. The CWADOS receives the encapsulated uplink data packets from the user device based on the transmitted packet forwarding information via the wireless access point. That is, the CWADOS receives the inner IP data packets, each encapsulated in an outer IP data packet on the Wi-Fi interface via the wireless access point. The outer IP data packet is also marked with the quality of service class associated with the traffic flow. The CWADOS extracts the uplink data packets, that is, the inner IP data packets from the encapsulated uplink data packets and performs a deep packet inspection of the extracted uplink data packets. The CWADOS maps traffic flow identifiers of the uplink traffic flows of the extracted uplink data packets to corresponding bearers on the S1-U interface based on an association created between the traffic flow identifiers of uplink traffic flows of previous uplink data packets received on the long term evolution (LTE) interface and the corresponding bearers on the S1-U interface. Based on the mapping of the traffic flow identifiers, the CWADOS forwards the extracted uplink data packets to the core network on the corresponding bearers of the S1-U interface.

In the above embodiment of forwarding the uplink data packets received from the user device via the established Wi-Fi interface to the core network on the S1-U interface, the cellular wireless access data offload system (CWADOS) in its request to forward uplink data packets on the Wi-Fi interface also includes the internet protocol (IP) address of the base station. The networking stack on the user device checks whether the traffic flow identifiers of the uplink traffic flows of the uplink data packets is one among the traffic flow identifiers of the uplink traffic flows requested to be sent on the Wi-Fi interface. If the traffic flow identifiers of the uplink traffic flows of the uplink data packets are among the traffic flow identifiers of the uplink traffic flows requested to be sent on the Wi-Fi interface, the networking stack encapsulates each of the uplink data packets, that is, the inner IP data packet, in an outer IP data packet. For the outer IP data packet, the source IP address is the address assigned to the Wi-Fi interface and the destination IP address is the IP address of the base station received by the user device from the packet forwarding information. The networking stack marks the quality of service (QoS) class associated with each of the uplink traffic flows in the outer IP data packet. The networking stack forwards the outer IP data packet to the wireless access point on the Wi-Fi interface.

In another embodiment of forwarding the uplink data packets received from the user device via the established Wi-Fi interface to the core network on the S1-U interface, the cellular wireless access data offload system (CWADOS) transmits the packet forwarding information for the uplink data packets to be forwarded via the established Wi-Fi interface to the user device. The packet forwarding information comprises, for example, traffic flow identifiers for uplink traffic flows and a corresponding quality of service class for each of the uplink traffic flows. In this embodiment, the packet forwarding information further comprises a request to replace a source internet protocol (IP) address of each of the uplink data packets with an IP address of the Wi-Fi interface. The CWADOS receives the uplink data packets from the user device based on the transmitted packet forwarding information on the Wi-Fi interface via the wireless access point. The source IP address of each of the uplink data packets is the IP address of the Wi-Fi interface replaced by the user device based on the transmitted packet forwarding information. Each uplink data packet is also marked with the quality of service class associated with the traffic flow. The CWADOS updates the source IP address of each of the received uplink data packets with the IP address of the long term evolution (LTE) interface prior to performing the deep packet inspection of each of the received uplink data packets. That is, the CWADOS replaces the source IP address of the uplink data packet with the packet data network connection IP address and performs a deep packet inspection of the received uplink data packets. The CWADOS maps the traffic flow identifiers of the uplink traffic flows of the received uplink data packets to corresponding bearers on the S1-U interface based on an association created between the traffic flow identifiers of the uplink traffic flows of previous uplink data packets received on the LTE interface and corresponding bearers on the S1-U interface. Based on the mapping of the traffic flow identifiers, the CWADOS forwards the received uplink data packets to the core network on the corresponding bearers on the S1-U interface.

In the above embodiment of forwarding the uplink data packets received from the user device via the established Wi-Fi interface to the core network on the S1-U interface, the cellular wireless access data offload system (CWADOS) in its request to forward uplink data packets on the Wi-Fi interface also requests the user device to configure the networking stack to replace the source internet protocol (IP) address of each of the uplink data packets with the Wi-Fi interface IP address. The networking stack on the user device checks whether the traffic flow identifiers of the uplink traffic flows of the uplink data packets are among the uplink traffic flows requested to be sent on the Wi-Fi interface. If the traffic flow identifiers of the uplink traffic flows of the uplink data packets are among the uplink traffic flows requested to be sent on the Wi-Fi interface, the networking stack on the user device replaces the source IP address of each of the uplink data packets with the Wi-Fi interface IP address. The networking stack marks the quality of service (QoS) class associated with the uplink traffic flows in the uplink data packets. The networking stack forwards the uplink data packets to the wireless access point on the Wi-Fi interface. In an embodiment, the CWADOS deactivates the Wi-Fi interface when the Wi-Fi interface is not in use.

The wireless access point forwards the data packets to the base station from where the data packets are received by the cellular wireless access data offload system (CWADOS). In an embodiment, the CWADOS distributes the forwarding of the downlink data packets from the core network to the user device and the uplink data packets from the user device to the core network between the long term evolution (LTE) interface and the Wi-Fi interface when multiple traffic flows are detected within a single bearer in the LTE network. For example, when the CWADOS detects multiple traffic flows related to electronic mail communication, video watching, playing games, browsing, downloading videos, downloading images, etc., within a single bearer in the LTE network, the CWADOS distributes the forwarding of the data packets from the core network to the user device and from the user device to the core network between the LTE interface and the Wi-Fi interface. In an embodiment, based on the Wi-Fi measurements received from the user device, the CWADOS dynamically switches to another wireless access point. The CWADOS performs this dynamic switching by first switching the data back to the LTE interface, identifying another suitable wireless access point, and then repeating the process of establishing the Wi-Fi interface and switching the data back to the new Wi-Fi interface. The CWADOS also detects that a handoff to another base station or another cell within the same base station is imminent and in this case, the CWADOS switches the data back to the LTE interface. The CWADOS proceeds with offloading the data to the Wi-Fi interface after the handoff is completed.

In the method disclosed herein, the cellular wireless access data offload system (CWADOS) determines an interface for forwarding data packets based on the switching criteria and the measurements for interfaces. The CWADOS receives the measurements, for example, a signal-to-interference-plus-noise ratio (SINR), a received signal strength indicator (RSSI), number of missed beacons, etc., for the Wi-Fi interface from the user device as input data. The switching criteria for switching between the long term evolution (LTE) interface and the Wi-Fi interface also constitute the input data to the CWADOS. The CWADOS processes the input data and transforms the input data into an output that defines the interface to transmit and receive downlink data packets and uplink data packets. On implementing the method disclosed herein to offload data from the LTE interface to the Wi-Fi interface, the end result is a seamless and dynamic switching between the LTE interface and the Wi-Fi interface. The seamless and dynamic switching between the LTE interface and the Wi-Fi interface obtained is tangible and not abstract. The seamless and dynamic switching is performed by the CWADOS without user intervention and provides enhanced user experience and capacity in the LTE network. Due to the increase in capacity of the LTE network, the user device can connect to the LTE network, to which connection was not possible previously because of network congestion. The method disclosed herein allows the user to experience an enhanced throughput, for example, download and upload speeds for data due to availability of the supplemental Wi-Fi interface.

On implementing the method disclosed herein by the cellular wireless access data offload system (CWADOS), the capacity of the base station improves due to selection of the Wi-Fi interface to route data packets between the user device and the base station. The data packets are offloaded to the wireless access point, for example, the Wi-Fi access point, and the processing, transmission, and reception of data packets by a long term evolution (LTE) stack in the base station on the LTE interface is avoided. The base station with additional capacity is now available to cater to an increased number of users, with increased throughput for the data packets of all the users. The increase in cumulative throughput is not at the cost of degrading the quality of the data packets of multiple users. The CWADOS implementation saves the cost of complex protocol stack modifications and upgrades to the base station and the user device. With existing hardware and an existing band of licensed spectrum, the CWADOS caters to an increased number of users and offers a larger cumulative throughput across all users, while not degrading the quality experienced by end users in any way. Furthermore, on performing offloading for downlink data packets only and not the uplink data packets, the throughput offered by the Wi-Fi access point substantially increases.

For purposes of illustration, the detailed description refers to offloading data from the long term evolution (LTE) interface to the Wi-Fi interface without impacting cellular wireless protocols of the LTE network; however the scope of the method and the cellular wireless access data offload system (CWADOS) disclosed herein is not limited to offloading data from the LTE interface to the Wi-Fi interface, but may be extended to offloading data from the LTE interface or an interface implemented in any other cellular technology to an interface implemented in any other communication technology in the unlicensed spectrum, for example, Bluetooth® of Bluetooth Sig, Inc., Zigbee® of Zigbee Alliance Corporation, WiMAX® of the WiMAX forum, etc., or the licensed spectrum, for example, a high speed packet access (HSPA) technology, a third generation (3G) mobile telecommunications technology, a fourth generation (4G) mobile telecommunications technology, a fifth generation (5G) mobile telecommunications technology, a code division multiple access (CDMA) communication technology, an enhanced data rates for global system for mobile communications (GSM) evolution (EDGE) technology, etc.

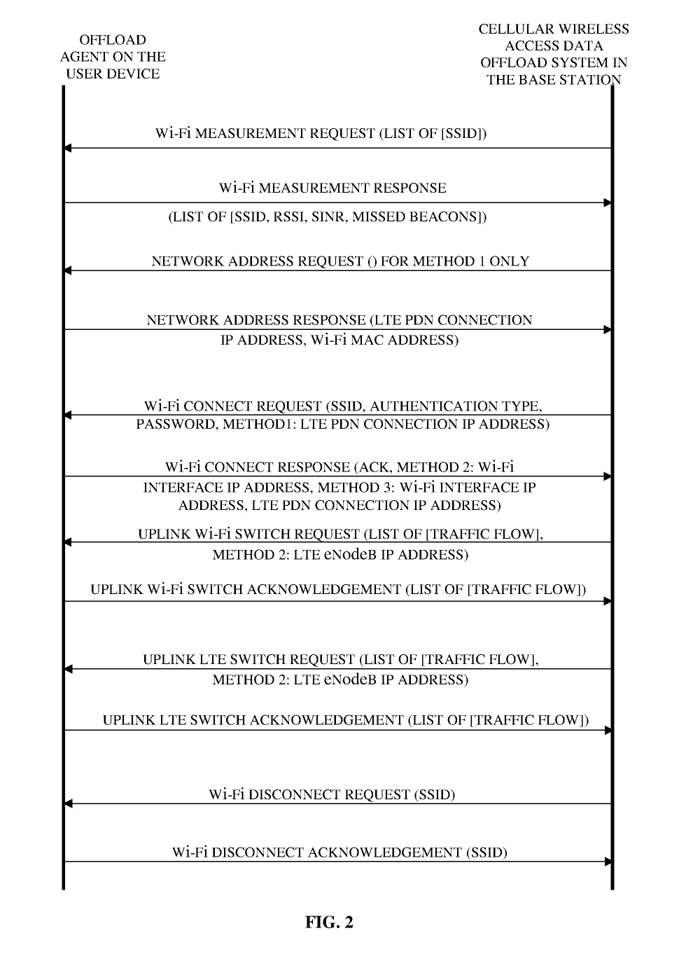

FIG. 2 exemplarily illustrates a message flow diagram showing communication between an offload agent deployed on a user device and the cellular wireless access data offload system (CWADOS) implemented in a base station for forwarding downlink data packets and for switching between the first cellular wireless communication interface, hereinafter referred to as the “long term evolution (LTE)” interface, and the second wireless communication interface, hereinafter referred to as the “Wi-Fi interface” for forwarding uplink data packets. The CWADOS transmits a request to the offload agent on the user device for measurements of the Wi-Fi interface, referred to as “Wi-Fi measurements”. The request for the Wi-Fi measurements comprises a list of service set identifiers (SSIDs) of wireless access points. The offload agent responds with a list of SSIDs and the Wi-Fi measurements comprising, for example, a received signal strength indicator (RSSI), a signal-to-interference-plus-noise ratio (SINR), number of missed beacons, etc. In an embodiment, the CWADOS transmits a request for a network address. The offload agent responds with the network address comprising, for example, a packet data network (PDN) connection internet protocol (IP) address and a Wi-Fi media access control (MAC) address. On receiving the response with the network address from the offload agent, the CWADOS sends a request to the user device for establishing a Wi-Fi connection with the wireless access point. The request comprises, for example, the SSID, an authentication type, a password, and in an embodiment, a PDN connection IP address. The PDN connection IP address is statically assigned as the IP address to the Wi-Fi interface. The offload agent responds to the request with an acknowledgement. In an embodiment, the CWADOS receives the Wi-Fi interface IP address from the offload agent. In another embodiment, the CWADOS receives the Wi-Fi interface IP address and the PDN connection IP address from the offload agent. The Wi-Fi interface IP address is present with the user device and only the user device can send the Wi-Fi interface IP address to the CWADOS unless the PDN connection IP address is also being used as the static IP address for the Wi-Fi interface.

The CWADOS sends a Wi-Fi interface switching request to the offload agent for forwarding uplink data packets to the core network. In an embodiment, the Wi-Fi interface switching request comprises the list of traffic flows. In an embodiment, the Wi-Fi interface switching request comprises the IP address of the base station, that is, the long term evolution (LTE) evolved node B (eNodeB) IP address. The offload agent in the user device responds with an uplink Wi-Fi interface switch acknowledgement comprising a list of traffic flows. The CWADOS sends an LTE interface switching request to the offload agent in the user device. The LTE interface switching request comprises a list of traffic flows. In an embodiment, the LTE interface switching request comprises the LTE eNodeB IP address. The offload agent responds with an uplink LTE interface switch acknowledgement comprising a list of traffic flows. The CWADOS sends a Wi-Fi interface disconnect request comprising the service set identifier (SSID) to the offload agent. The offload agent sends a Wi-Fi disconnect acknowledgement comprising the SSID to the CWADOS.

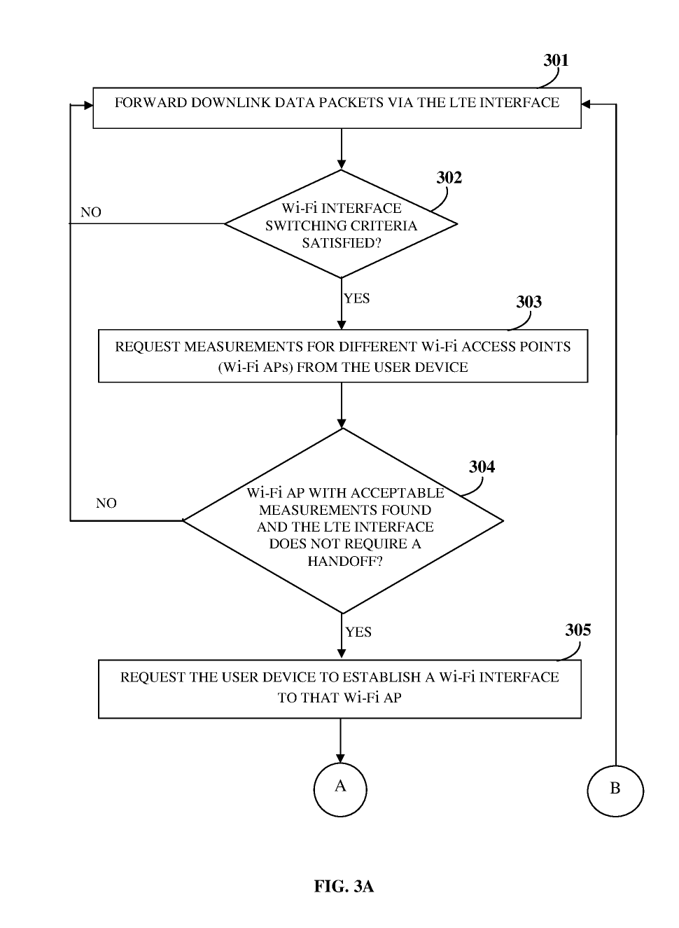

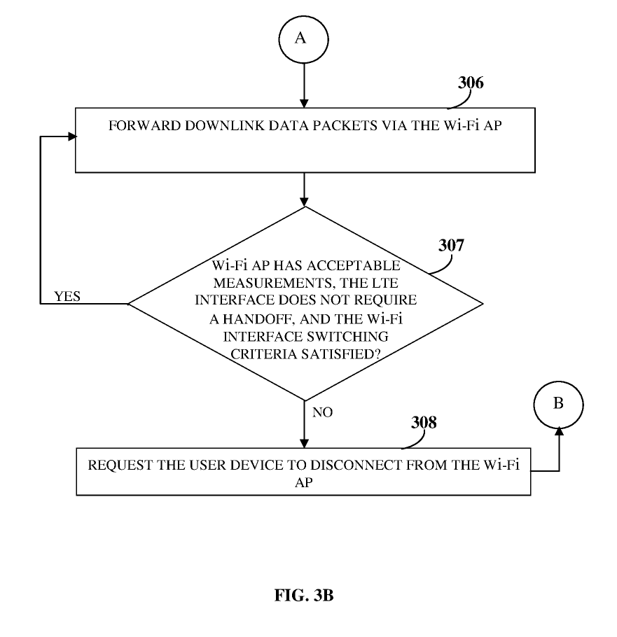

FIGS. 3A-3B exemplarily illustrate a flowchart comprising steps for offloading downlink data packets from the first cellular wireless communication interface, hereinafter referred to as the “long term evolution (LTE) interface” to the second wireless communication interface, hereinafter referred to as the “Wi-Fi interface”. The CWADOS forwards 301 the downlink data packets received from the core network to the user device via the LTE interface. The CWADOS acquires dynamic measurements from the user device and determines 302 whether the Wi-Fi interface switching criteria to switch from the LTE interface to the Wi-Fi interface is satisfied. If the Wi-Fi interface switching criteria are not satisfied, the forwarding 301 of the downlink data packets to the user device continues on the LTE interface. If the Wi-Fi interface switching criteria to switch from the LTE interface to the Wi-Fi interface are satisfied, the CWADOS requests 303 measurements for different wireless access points, for example, Wi-Fi access points (Wi-Fi APs), from the user device. The CWADOS further determines 304 whether a Wi-Fi AP with acceptable measurements is located and whether the LTE interface does not require a handoff, where “handoff” refers to a process of transferring data packets from one LTE interface to another LTE interface when the user device is in motion.

If a Wi-Fi access point (Wi-Fi AP) with acceptable measurements is not found and the long term evolution (LTE) interface requires a handoff, the CWADOS aborts the offloading of the downlink data packets to the Wi-Fi interface and forwards 301 the downlink data packets to the user device on the LTE interface. If a Wi-Fi AP with acceptable measurements is located and the LTE interface does not require handoff, the CWADOS requests 305 the user device to establish a Wi-Fi interface to the Wi-Fi AP that was found. The CWADOS forwards 306 the downlink data packets to the user device via the Wi-Fi AP. The CWADOS dynamically determines 307 whether the Wi-Fi AP has acceptable measurements, whether the LTE interface does not require a handoff, and whether the Wi-Fi interface switching criteria to switch from the LTE interface to the Wi-Fi interface is satisfied. If the determined conditions are not met, the CWADOS requests 308 the user device to disconnect from the Wi-Fi AP, aborts the offloading of the downlink data packets via the Wi-Fi interface, and switches to the LTE interface for forwarding 301 the downlink data packets to the user device via the LTE interface. If the conditions are met, the CWADOS continues to forward 306 the downlink data packets to the user device via the Wi-Fi AP.

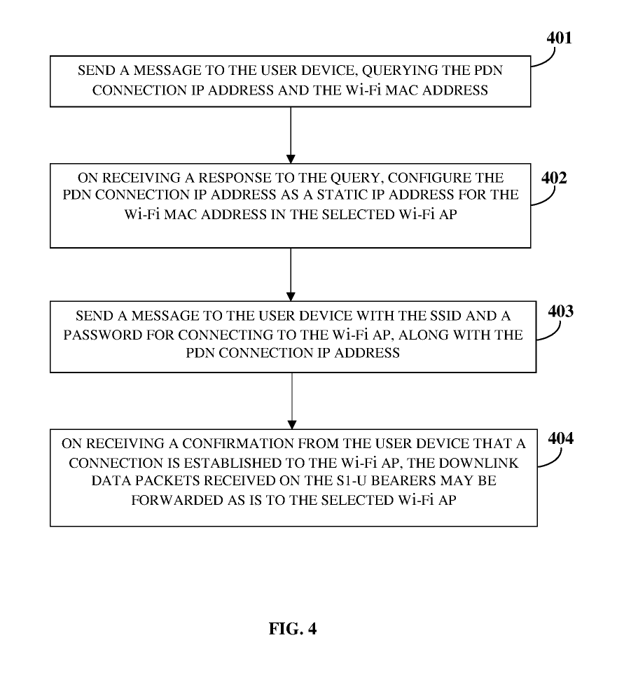

FIG. 4 exemplarily illustrates a flowchart comprising steps of a method for establishing a connection between the user device and a wireless access point and forwarding downlink data packets on the second wireless communication interface, hereinafter referred to as the “Wi-Fi interface” to the user device. The cellular wireless access data offload system (CWADOS) in the base station sends 401 a message to the user device, querying the user device for the packet data network (PDN) connection internet protocol (IP) address, and the Wi-Fi media access control (MAC) address. On receiving a response to the query from the user device, the CWADOS configures 402 the PDN connection IP address as a static IP address for the Wi-Fi MAC address in a selected wireless access point, for example, a Wi-Fi access point (Wi-Fi AP). On configuring the Wi-Fi AP, the CWADOS sends 403 a message to the user device with the service set identifier (SSID) and a password for connecting to the Wi-Fi AP along with the PDN connection IP address. On receiving a confirmation from the user device that a connection is established to the Wi-Fi AP, the CWADOS forwards 404 the downlink data packets received on the S1-U bearers to the selected Wi-Fi AP on the Wi-Fi interface.

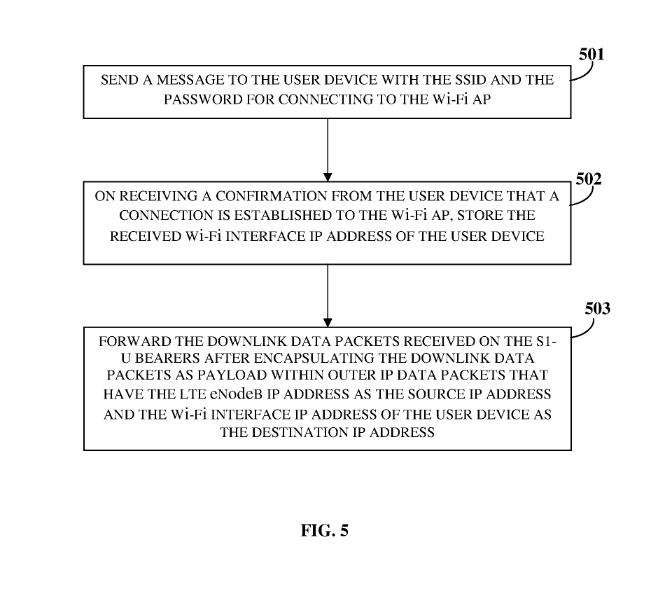

FIG. 5 exemplarily illustrates a flowchart comprising steps of an embodiment of the method for establishing a connection between the user device and a wireless access point and forwarding downlink data packets on the second wireless communication interface, hereinafter referred to as the “Wi-Fi interface”, to the user device. The cellular wireless access data offload system (CWADOS) sends 501 a message to the user device with the service set identifier (SSID) and the password for connecting to the wireless access point, for example, the Wi-Fi access point (Wi-Fi AP). On receiving a confirmation from the user device that a connection is established to the Wi-Fi AP, the CWADOS stores 502 the received Wi-Fi interface internet protocol (IP) address of the user device. The CWADOS encapsulates the downlink data packets received on the S1-U bearers as payload within outer IP data packets. The source IP address of each of the outer IP data packets is the long term evolution (LTE) evolved node B (eNodeB) IP address, and the destination IP address of each of the outer IP data packets is the Wi-Fi interface IP address of the user device. The CWADOS forwards 503 the encapsulated downlink data packets to the user device via the Wi-Fi AP on the Wi-Fi interface.

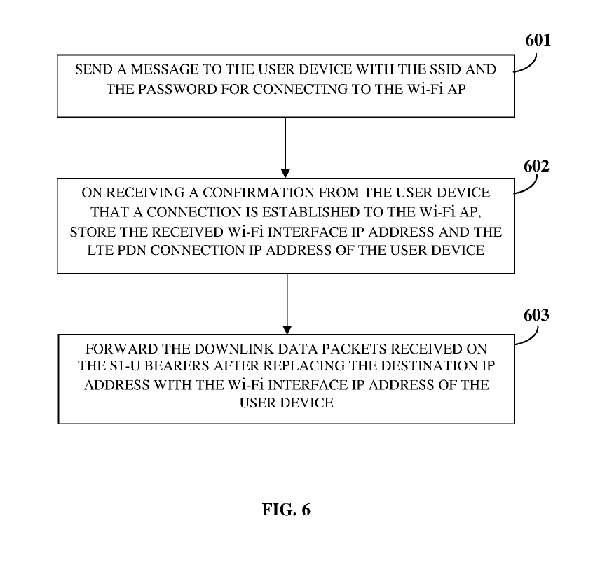

FIG. 6 exemplarily illustrates a flowchart comprising steps of another embodiment of the method for establishing a connection between the user device and the wireless access point and forwarding the downlink data packets on the second wireless communication interface, hereinafter referred to as the “Wi-Fi interface”, to the user device. The cellular wireless access data offload system (CWADOS) sends 601 a message to the user device with the service set identifier (SSID) and the password for connecting to the wireless access point, for example, the Wi-Fi access point (Wi-Fi AP). On receiving a confirmation from the user device that a connection is established to the Wi-Fi AP, the CWADOS stores 602 the received Wi-Fi interface internet protocol (IP) address and the long term evolution (LTE) packet data network (PDN) connection IP address of the user device. The CWADOS replaces the destination IP address of each of the downlink data packets received on the S1-U bearers with the Wi-Fi interface IP address of the user device and forwards 603 the downlink data packets to the user device via the Wi-Fi AP on the Wi-Fi interface.

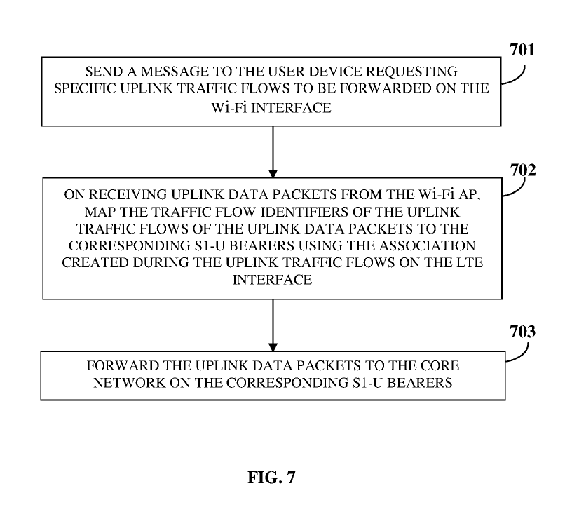

FIG. 7 exemplarily illustrates a flowchart comprising steps of a method for switching between the first cellular wireless communication interface, hereinafter referred to as the “long term evolution (LTE) interface”, and the second wireless communication interface, hereinafter referred to as the “Wi-Fi interface” and forwarding uplink data packets to a core network on a cellular wireless network interface hereinafter referred to as the “S1-U interface”. The cellular wireless access data offload system (CWADOS) sends 701 a message to the user device requesting the user device to forward specific uplink traffic flows on the Wi-Fi interface. On receiving the uplink data packets from the wireless access point, for example, the Wi-Fi access point (Wi-Fi AP), the CWADOS maps 702 the traffic flow identifiers of the uplink traffic flows of the uplink data packets to the corresponding S1-U bearers using the association created during the uplink traffic flows on the LTE interface. The CWADOS forwards 703 the uplink data packets to the core network on the corresponding S1-U bearers.

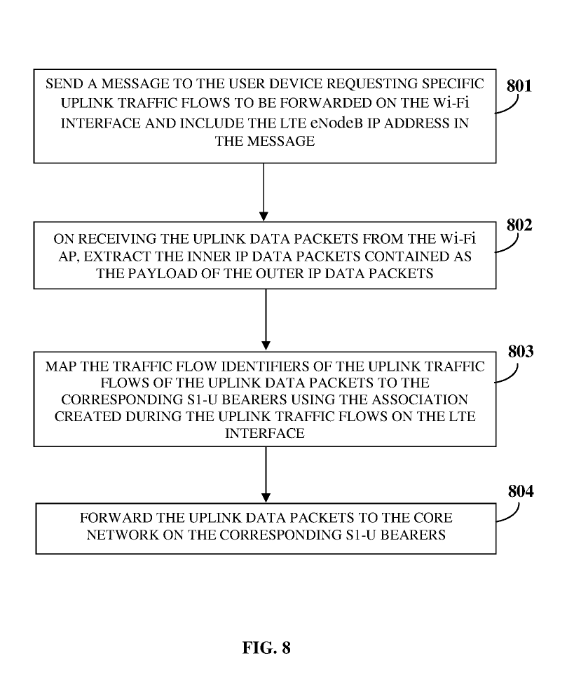

FIG. 8 exemplarily illustrates a flowchart comprising steps of an embodiment of the method for switching between the first cellular wireless communication interface, hereinafter referred to as the “long term evolution (LTE) interface”, and the second wireless communication interface, hereinafter referred to as “the Wi-Fi interface”, and forwarding uplink data packets to the core network on the cellular wireless network interface, hereinafter referred to as the “S1-U interface”. The cellular wireless access data offload system (CWADOS) sends 801 a message to the user device with packet forwarding information, comprising the LTE evolved node B (eNodeB) internet protocol (IP) address, requesting the user device to forward specific uplink traffic flows on the Wi-Fi interface. On receiving the uplink data packets from the wireless access point, for example, the Wi-Fi access point (Wi-Fi AP), the CWADOS extracts 802 the inner IP data packets contained as the payload of the outer IP data packets. The CWADOS maps 803 the traffic flow identifiers of the uplink traffic flows of the uplink data packets to the corresponding S1-U bearers using the association created during the uplink traffic flows on the LTE interface and forwards 804 the uplink data packets to the core network on the corresponding S1-U bearers.

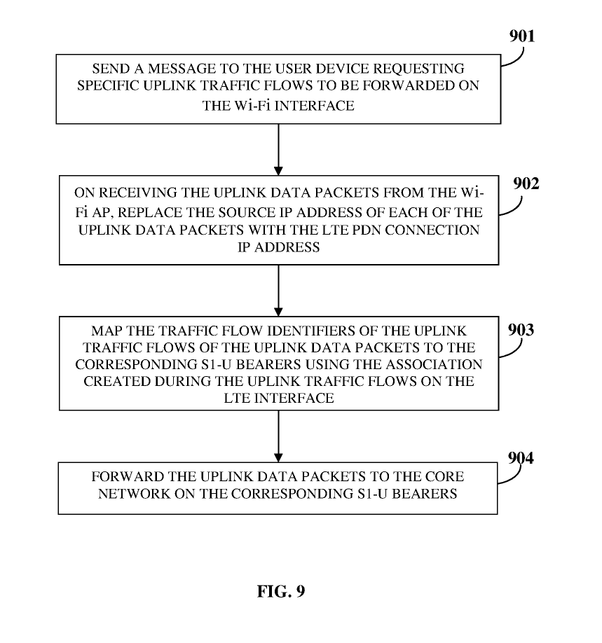

FIG. 9 exemplarily illustrates a flowchart comprising steps of another embodiment of the method for switching between the first cellular wireless communication interface, hereinafter referred to as the “long term evolution (LTE) interface”, and the second wireless communication interface, hereinafter referred to as the “Wi-Fi interface”, and forwarding uplink data packets to the core network on the cellular wireless network interface, hereinafter referred to as the “S1-U interface”. The cellular wireless access data offload system (CWADOS) sends 901 a message to the user device with packet forwarding information, requesting the user device to forward specific uplink traffic flows on the Wi-Fi interface. On receiving the uplink data packets from the wireless access point, for example, the Wi-Fi access point (Wi-Fi AP), the CWADOS replaces 902 the source internet protocol (IP) address of each of the uplink data packets with the LTE packet data network (PDN) connection IP address. The CWADOS maps 903 the traffic flow identifiers of the uplink traffic flows of the uplink data packets to the corresponding S1-U bearers using the association created during the uplink traffic flows on the LTE interface and forwards 904 the uplink data packets to the core network on the corresponding S1-U bearers.

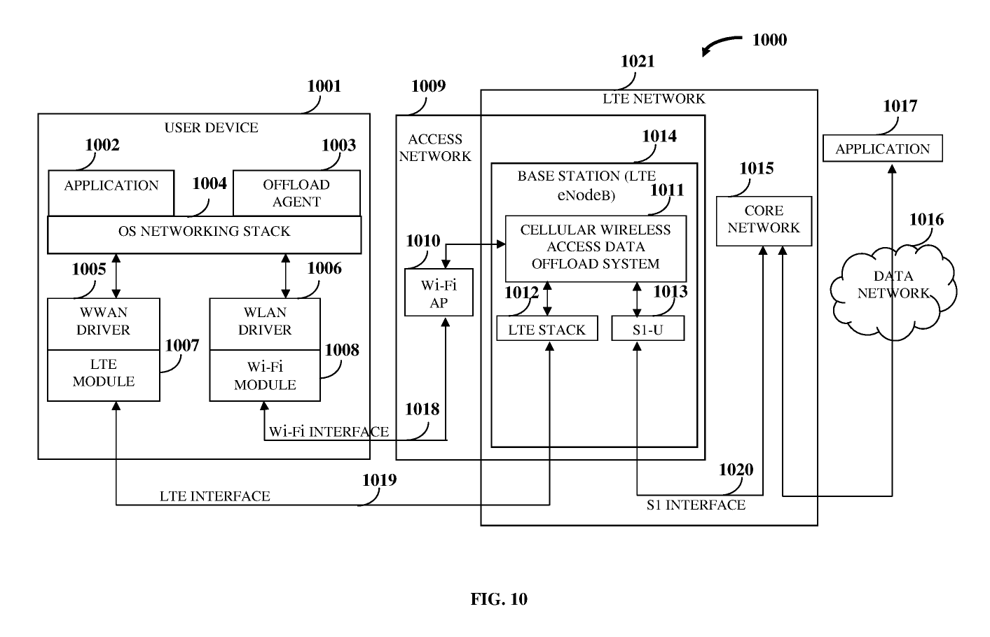

FIG. 10 exemplarily illustrates a communications system 1000 for offloading data from the first cellular wireless communication interface, hereinafter referred to as the “long term evolution (LTE) interface”, to the second wireless communication interface, hereinafter referred to as the “Wi-Fi interface”, without impacting cellular wireless protocols of the cellular wireless communication network, hereinafter referred to as the “LTE network”. As exemplarily illustrated in FIG. 10, the communications system 1000 disclosed herein comprises a user device 1001, an access network 1009, a core network 1015, and an application 1017 hosted on one or more servers that are connected to a data network 1016, interfaces 1018, 1019, and 1020 for communication and bearers on the interfaces 1018, 1019, and 1020 to carry data packets. The access network 1009 for the communications system 1000 comprises one or more wireless access points 1010, hereinafter referred to as the “Wi-Fi access points (Wi-Fi APs)”, and the base station 1014, that is, the LTE evolved node B (eNodeB) that connects to the user device 1001 via the LTE interface 1019. The access network 1009 is a part of the LTE network 1021 that provides wireless interfaces 1018 and 1019 to the user device 1001 via the base station 1014 and the Wi-Fi AP 1010.

For the purpose of offloading data from the long term evolution (LTE) interface 1019 to the Wi-Fi interface 1018, the Wi-Fi access point (Wi-Fi AP) 1010 is implemented in the access network 1009 along with the base station 1014. The Wi-Fi AP 1010 is a standard access point that provides for Wi-Fi connections and routing, and allows remote configuration via an application protocol, for example, a hypertext transfer protocol (HTTP). One or more Wi-Fi APs 1010 are positioned within the base station 1014 or adjacent to the base station 1014 or are distributed physically from the base station 1014. In an embodiment, the Wi-Fi AP 1010 is positioned at a first location within the base station 1014 of the LTE network 1021 as exemplarily illustrated in FIG. 10. In another embodiment (not shown), the Wi-Fi AP 1010 is positioned at a second location adjacent to the base station 1014. In another embodiment (not shown), the Wi-Fi AP 1010 is positioned at a third location away from the base station 1014. That is, the Wi-Fi AP 1010 is either integrated into a single base station 1014 or implemented as separate physical entities. One base station 1014 is associated with multiple Wi-Fi APs 1010 and one Wi-Fi AP 1010 is associated with multiple base stations 1014. The cellular wireless access data offload system (CWADOS) 1011 is located in the base station 1014 and is accessible to the user device 1001 on the LTE interface 1019 or the Wi-Fi interface 1018.

The base station 1014 and the core network 1015 together form the long term evolution (LTE) network 1021. The LTE network 1021 comprises the evolved universal terrestrial radio access network (EUTRAN) and the core network 1015, that is, an LTE evolved packet core (EPC) network. The EUTRAN comprises multiple LTE evolved node Bs (eNodeBs). The core network 1015 comprises a mobility management entity (MME), a serving gateway (SGW), a packet data network gateway (PDN GW), a policy control resource function (PCRF), a home subscriber system (HSS), etc. The core network 1015 is responsible for control of the user device 1001 and establishment of bearers of different interfaces, for example, an S1 interface 1020 for communication between the user device 1001 and the data network 1016. The communication between the base station 1014 and the core network 1015 occurs on the S1 interface 1020. Within the LTE network 1021, data packets are carried from the core network 1015 to the base station 1014 and vice versa over a user plane of the S1 interface 1020, herein referred to as the “S1-U interface”. Each bearer in the data network connection has a corresponding bearer on the S1-U interface referred to as an S1-U bearer. An S1-U bearer corresponds to a general packet radio service (GPRS) tunneling protocol (GTP) tunnel on the S1 interface 1020. The data network 1016 of the communications system 1000 refers to a private data network or a public data network, for example, the internet. The data network 1016 is a collection of information resources and services accessed by the user device 1001 via the access network 1009 of a cellular service provider. The application 1017 on the server side resides on the data network 1016 and is accessible to the user device 1001 via the access network 1009 using the LTE interface 1019 or the Wi-Fi interface 1018.

The cellular wireless access data offload system (CWADOS) 1011 is located in the base station 1014, and is accessible to the user device 1001 on the Wi-Fi interface 1018 and the long term evolution (LTE) interface 1019. The CWADOS 1011 is implemented in hardware and/or software of the base station 1014. The communication between an application 1002 on the user device 1001 and the application 1017 on the server side is in the form of data packets through the data network 1016. The data packets comprise, for example, internet protocol (IP) data packets containing transmission control protocol (TCP) data packets or user datagram protocol (UDP) data packets. The TCP data packets or the UDP data packets carry higher layer protocols that are used to exchange data between the application 1002 on the user device 1001 and the application 1017 on the server side through the data network 1016. The user device 1001 establishes a connection to the data network 1016 via the LTE interface 1019 or the Wi-Fi interface 1018 when a unique IP address is assigned to the connection and the assigned IP address is associated to the LTE interface 1019 or the Wi-Fi interface 1018.

The user device 1001, also referred to as “user equipment”, is a network enabled electronic device, for example, a tablet computing device, a mobile computer, an universal serial bus data modem, a mobile phone, a smartphone, a personal digital assistant, an interactive network enabled communication device, etc. In an embodiment, the user device 1001 is a hybrid device that combines the functionality of multiple devices. Examples of a hybrid electronic device comprise a cellular telephone that includes media player functionality, a gaming device that includes a wireless communications capability, a cellular telephone that includes game and electronic mail (email) functions, and a portable device that receives email, supports mobile telephone calls, has music player functionality, and supports web browsing. The application 1002 on the user device 1001 is connected to the data network 1016 via the long term evolution (LTE) interface 1019 or the Wi-Fi interface 1018. The application 1002 refers to a client side user application, for example, an email application, a video sharing application such as YouTube® of Google Inc., WhatsApp® of WhatsApp Inc., Skype of Microsoft Corporation, a web browser, a mapping application, etc.

In addition to the application 1002, the user device 1001 comprises an offload agent 1003, an operating system (OS) networking stack 1004, a wireless wide area network (WWAN) driver 1005 for the long term evolution (LTE) interface 1019, a wireless local area network (WLAN) driver 1006 for the Wi-Fi interface 1018, an LTE module 1007, and a Wi-Fi module 1008. The offload agent 1003 that resides in the user device 1001 is an application on an operating system of the user device 1001 that communicates with the cellular wireless access data offload system (CWADOS) 1011 in the base station 1014 via a data radio bearer on the LTE interface 1019 using the transmission control protocol (TCP), the user datagram protocol (UDP), or internet protocol (IP) data packets. The operating system of the user device 1001 is, for example, the Android® operating system of Google Inc., or Windows® operating system of Microsoft Corporation, or the iOS operating system of Apple Inc. In an embodiment, the operating system of the user device 1001 updates a source network address and a destination network address of each of downlink data packets and uplink data packets. The offload agent 1003 of the user device 1001 listens on a predetermined port for wireless connection identification information. The offload agent 1003 receives the wireless connection identification information, also referred as “wireless access point information” comprising, for example, the service set identifier (SSID) and the authentication information from the CWADOS 1011, activates the Wi-Fi module 1008 of the user device 1001 if the Wi-Fi module 1008 was switched off by a user, and establishes a connection with the Wi-Fi access point (Wi-Fi AP) 1010.

To offload data packets to the Wi-Fi interface 1018 from the long term evolution (LTE) interface 1019, the offload agent 1003 configures the IP address received from the cellular wireless access data offload system (CWADOS) 1011 as the static IP address for the Wi-Fi access point (Wi-Fi AP) connection. The offload agent 1003 also configures routing in the OS networking stack 1004 based on the uplink packet forwarding information received from the CWADOS 1011. In an embodiment, the offload agent 1003 reports the IP address assigned by the Wi-Fi AP 1010 to the CWADOS 1011 and configures encapsulation of the uplink data packets in the OS networking stack 1004 based on the uplink packet forwarding information received from the CWADOS 1011. In another embodiment, the offload agent 1003 configures a change or an update of the source IP address to the IP address assigned by the Wi-Fi AP 1010 when transmitting uplink data packets and configures a change or an update of the destination IP address to the LTE packet data network (PDN) connection IP address for the received downlink data packets. In addition to the functions performed for different embodiments of offloading of data packets, the offload agent 1003 of the user device 1001 acquires and forwards the Wi-Fi connection measurements required by the CWADOS 1011 from the wireless local area network (WLAN) driver 1006 to the CWADOS 1011 and deactivates the Wi-Fi module 1008 on receiving a request from the CWADOS 1011, if the Wi-Fi module 1008 was switched off or deactivated prior to the initial activation.

The operating system (OS) networking stack 1004 is a part of the operating system of the user device 1001. The OS networking stack 1004 in the user device 1001 is enhanced to perform multiple functions. The OS networking stack 1004 allows the Wi-Fi interface 1018 to be used as a tunnel for carrying information that is carried on the long term evolution (LTE) interface 1019. To offload data packets to the Wi-Fi interface 1018 from the LTE interface 1019, the OS networking stack 1004 assigns the same internet protocol (IP) address to the LTE interface 1019 and the Wi-Fi interface 1018 for forwarding the data packets by the cellular wireless access data offload system (CWADOS) 1011. The Wi-Fi interface 1018 functions as a tunnel for carrying data packets that are carried on the LTE interface 1019. In an embodiment, the OS networking stack 1004 configures the routing of uplink data packets to the Wi-Fi interface 1018 based on the uplink traffic flows, configures the encapsulation of uplink data packets in outer data packets based on the uplink traffic flows, forwards the encapsulated uplink data packets on the Wi-Fi interface 1018, and receives encapsulated downlink data packets, extracts the downlink data packets from outer data packets, and forwards the extracted downlink data packets to the application 1002 on the user device 1001. In another embodiment, the OS networking stack 1004 configures a change or an update of the source IP address for transmitted uplink data packets and a change or an update of the destination IP address for received downlink data packets.

The wireless wide area network (WWAN) driver 1005 and the wireless local area network (WLAN) driver 1006 are device drivers implemented in the operating system (OS) of the user device 1001. The WWAN driver 1005 and the WLAN driver 1006 allow the OS networking stack 1004 to use services provided by the long term evolution (LTE) module 1007 and the Wi-Fi module 1008 in the user device 1001. The LTE module 1007 in the user device 1001 refers to a hardware module and/or a software module on the user device 1001 that provides LTE interface functionality of communicating with the core network 1015 and the data network 1016 via the base station 1014 on the LTE interface 1019. The Wi-Fi module 1008 on the user device 1001 refers to a hardware module and/or a software module on the user device 1001 that provides Wi-Fi interface functionality of communicating with the core network 1015 and the data network 1016 via the base station 1014 on the Wi-Fi interface 1018. For traffic flows via the LTE interface 1019 and the Wi-Fi interface 1018, the path up to the base station 1014 remains the same. Furthermore, there is no change to an LTE stack 1012, that is, a Layer 2 protocol stack of the base station 1014, the Wi-Fi access point (Wi-Fi AP) 1010, the Wi-Fi module 1008 on the user device 1001, the WWAN driver 1005 on the user device 1001 and the WLAN driver 1006 on the user device 1001.

For bearers with quality of service (QoS) requirements that can be satisfied by Wi-Fi access points (Wi-Fi APs) 1010, the base station 1014 offloads traffic flows in both downlink and uplink directions to the Wi-Fi interface 1018. This bidirectional offload to the Wi-Fi interface 1018 allows the base station 1014 to cater to users with more stringent QoS requirements on the long term evolution (LTE) interface 1019 or even to distribute the required bandwidth between the LTE interface 1019 and the Wi-Fi interface 1018. The base station 1014 switches between the LTE interface 1019 and the Wi-Fi interface 1018 based on the switching criteria disclosed in the detailed description of FIG. 1. The cellular wireless access data offload system (CWADOS) 1011 in the base station 1014 maintains a candidate list of Wi-Fi APs 1010 for offloading data from the LTE interface 1019; acquires information on the loading of the Wi-Fi APs 1010 and the loading on the Wi-Fi interfaces 1018 provided by those Wi-Fi APs 1010; sends the service set identifier (SSID) and the authentication information to the user device 1001; performs different methods of offloading of data packets; requests for measurements that aid in dynamically selecting a Wi-Fi AP 1010 to which data can be offloaded; requests for measurements that aid in dynamically switching data from the LTE interface 1019 to the Wi-Fi interface 1018 and vice versa; forwards downlink data packets on the selected interface 1019 or 1018; creates a mapping of traffic flows to the corresponding S1-U bearers based on the received uplink data packets on the LTE interface 1019; utilizes the created mapping to forward uplink data packets received on the Wi-Fi interface 1018 on the corresponding S1-U bearer; minimizes power consumption on the user device 1001 by ensuring that the Wi-Fi interface 1018 is activated only when the Wi-Fi interface 1018 can be efficiently used and switched-off otherwise; and moves the data back to the LTE interface 1019 when the LTE connection needs to be handed-off to another base station 1014.

In a first method of offloading data packets, the cellular wireless access data offload system (CWADOS) 1011 acquires the internet protocol (IP) address allocated for each packet data network (PDN) connection from the user device 1001, acquires the Wi-Fi media access control (MAC) address from the user device 1001, and configures a PDN connection IP address as a static IP address for the Wi-Fi MAC address in the Wi-Fi access point (Wi-Fi AP) 1010. In a second method of offloading data packets, the CWADOS 1011 encapsulates each of the downlink data packets in an outer IP data packet for tunneling via the Wi-Fi AP 1010, and extracts the uplink data packets from the outer IP data packets received via the Wi-Fi AP 1010. In a third method of offloading data packets, the CWADOS 1011 changes or updates the destination IP address of the downlink data packets to the IP address assigned to the user by the Wi-Fi AP 1010, acquires the IP address allocated for each PDN connection from the user device 1001, and changes the source IP address of the uplink data packets to the PDN connection IP address.

The cellular wireless access data offload system (CWADOS) 1011 in the base station 1014 communicates with the user device 1001 and the core network 1015 via the long term evolution (LTE) interface 1019 and the S1 interface 1020. To communicate with the LTE module 1007 of the user device 1001 on the LTE interface 1019, the CWADOS 1011 uses the LTE stack 1012 of the base station 1014. The LTE stack 1012 refers to the complete LTE functionality in the base station 1014 comprising, for example, operations, administration and maintenance (OAM), radio resource management (RRM), local resource management, network resource management, cell management, user device connection management, radio interface protocol stack functions, S1 control plane protocol stack functions, and self-optimizing network (SON) functions. To communicate with the core network 1015 via the S1 interface 1020, the CWADOS 1011 uses an S1-U stack 1013 of the base station 1014. The S1-U stack 1013 is a user plane protocol stack on the S1 interface 1020 between the base station 1014 and the core network 1015 and comprises a general packet radio service (GPRS) tunneling protocol-user plane protocol transported over a user datagram protocol or an internet protocol. In an embodiment, each of the modules of the communications system 1000 is implemented on an independent integrated circuit (IC) or in an independent set of ICs mounted on separate printed circuit boards (PCBs) that are interconnected or implemented as functional blocks in an integrated System-on-Chip (SoC). In an embodiment, the modules of the communications system 1000 are co-located or located in different geographical locations. By the implementation of the CWADOS 1011, an end user receives continuous wireless coverage and extra bandwidth for different applications due to the use of two interfaces, that is, the LTE interface 1019 and the Wi-Fi interface 1018 at the same time. The access network 1009 will be able to serve more users since the capacity of the LTE interface 1019 is now supplemented by the capacity of the Wi-Fi interface 1018.

In an embodiment, a protocol with reserved user datagram protocol (UDP) ports are used between the base station 1014 and the user device 1001 for communication regarding offloading data on the Wi-Fi interface 1018 and allowing development of value added applications. This protocol allows a separate policy to be used for switching uplink data packets between the LTE interface 1019 and the Wi-Fi interface 1018.

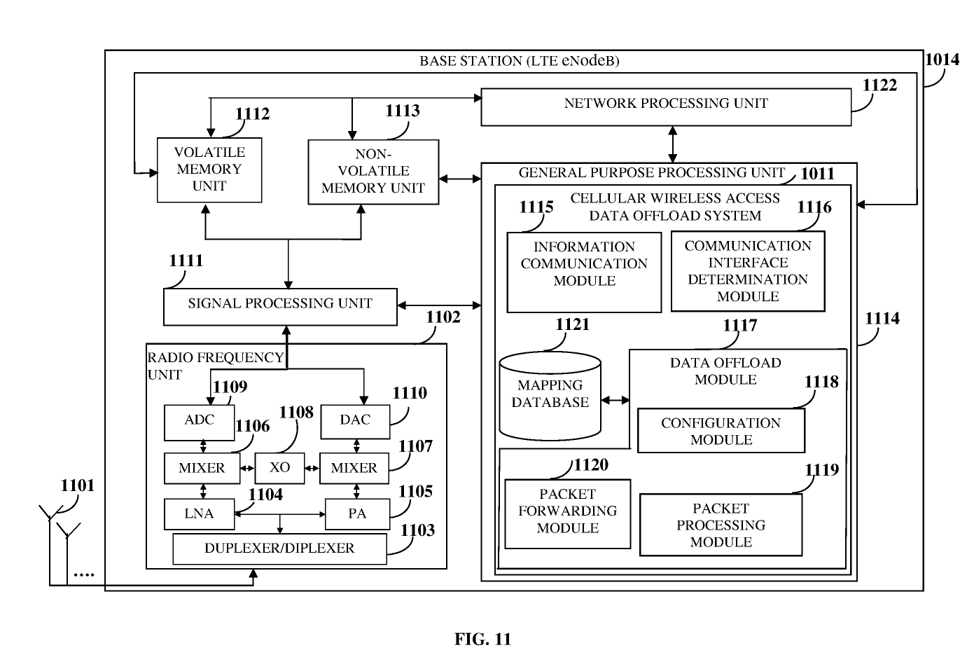

FIG. 11 exemplarily illustrates a block diagram of the base station 1014 comprising the cellular wireless access data offload system (CWADOS) 1011 for offloading data from the first cellular wireless communication interface, hereinafter referred to as the “long term evolution (LTE) interface”, to the second wireless communication interface, hereinafter referred to as the “Wi-Fi interface”, without impacting cellular wireless protocols of the cellular wireless communication network, hereinafter referred to as the “LTE network”. An example of the base station 1014 is an evolved Node B (eNodeB). The base station 1014 is implemented as a single unit at a location or as multiple functional units at a location or as multiple functional units distributed across locations. As exemplarily illustrated in FIG. 11, the base station 1014 disclosed herein comprises one or more antennas 1101, a radio frequency (RF) unit 1102, multiple processors such as a signal processing unit 1111, a network processing unit 1122, and a general purpose processing unit 1114, the CWADOS 1011 executable by at least one processor, for example, 1114, and non-transitory computer readable storage media comprising, for example, a volatile memory unit 1112 and a non-volatile memory unit 1113. As used herein, “non-transitory computer readable storage media” refers to all computer readable media, for example, non-volatile media such as optical discs or magnetic disks, volatile media such as a register memory, a processor cache, etc., and transmission media such as wires that constitute a system bus coupled to the processors 1111, 1114, and 1122, except for a transitory, propagating signal. The non-transitory computer readable storage media is communicatively coupled to the processors 1111, 1114, and 1122 and configured to store computer program instructions defined by the modules, for example, 1115, 1116, 1117, etc., of the CWADOS 1011. The processors 1111, 1114, and 1122 execute the defined computer program instructions.

The radio frequency unit 1102 is operably coupled to one or more antennas 1101 of the base station 1014. The radio frequency unit 1102 is a hardware module that performs the functions of converting signals between digital and analog forms, modulation, frequency conversion, amplification, filtering, and transmission and reception of radio frequency electromagnetic waves via one or more antennas 1101. The radio frequency unit 1102 transmits and receives radio frequency electromagnetic waves via the antennas 1101, and processes radio frequency signals transmitted and received via the antennas 1101. As exemplarily illustrated in FIG. 11, the radio frequency unit 1102 comprise a duplexer and/or a diplexer 1103, a low noise amplifier (LNA) 1104, a power amplifier (PA) 1105, mixers 1106 and 1107, a crystal oscillator (XO) 1108, a digital to analog converter (DAC) 1110, and an analog to digital converter (ADC) 1109 for processing the radio frequency signals. The duplexer and/or the diplexer 1103 in the radio frequency unit 1102 enables the antennas 1101 to transmit and receive radio frequency signals simultaneously and transmit and receive radio frequency signals of different frequencies. The low noise amplifier 1104 amplifies the radio frequency signals received from the antennas 1101 via the duplexer and/or the diplexer 1103 and communicates the amplified radio frequency signals to the mixer 1106. The power amplifier 1105 converts a low-power radio frequency signal into a radio frequency signal of significant power for driving the antennas 1101 of the base station 1014 to transmit radio frequency signals. The mixers 1106 and 1107 of the radio frequency unit 1102 convert the radio frequency signals from one frequency band to another frequency band for optimizing transmission and reception by the antennas 1101 and further signal processing. The crystal oscillator 1108 in the radio frequency unit 1102 interacts with the mixers 1106 and 1107 for converting the radio frequency signal from one frequency band to another frequency band. The digital to analog converter 1110 performs digital to analog conversion of the radio frequency signals and communicates the converted radio frequency signals to the mixer 1107. The analog to digital converter 1109 performs analog to digital conversion of the mixed radio frequency signals and communicates the converted radio frequency signals to the signal processing unit 1111.

The processors 1111, 1114, and 1122 of the base station 1014 refer to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processors 1111, 1114, and 1122 are selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The cellular wireless access data offload system (CWADOS) 1011 disclosed herein is not limited to employing processors 1111, 1114, and 1122. In an embodiment, the CWADOS 1011 employs a controller or a microcontroller. At least one of the processors 1111, 1114, and 1122 execute the computer program instructions defined by the CWADOS 1011. The signal processing unit 1111 is communicatively coupled to the radio frequency unit 1102. The signal processing unit 1111 communicates with the radio frequency unit 1102, modulates and demodulates the converted radio frequency signals from the analog to digital converter 1109 and the digital to analog converter 1110, and implements computation intensive software functions involving extensive mathematical functions. The network processing unit 1122 processes downlink data packets received from the core network 1015 exemplarily illustrated in FIG. 10, and uplink data packets to be transmitted to the core network 1015. In an embodiment, the processing of data packets by the network processing unit 1122 comprises deep packet inspection of the uplink data packets, packet filter generation on performing the deep packet inspection of the uplink data packets, and packet forwarding to the user device 1001 or the core network 1015 exemplarily illustrated in FIG. 10. The general purpose processing unit 1114 is communicatively coupled to the radio frequency unit 1102 via the signal processing unit 1111. The general purpose processing unit 1114 executes software instructions that involve moving memory from one storage location to another storage location, comparisons, and implementation of communication interface switching logic.

In an embodiment as exemplarily illustrated in FIG. 11, the cellular wireless access data offload system (CWADOS) 1011 is implemented in the general purpose processing unit 1114. The CWADOS 1011 comprises an information communication module 1115, a communication interface determination module 1116, a data offload module 1117, and a mapping database 1121. The information communication module 1115 transmits wireless connection identification information to the user device 1001 on a bearer of the long term evolution (LTE) interface 1019 using a communication protocol for establishing the Wi-Fi interface 1018 between the user device 1001 and the wireless access point, hereinafter referred to as the “Wi-Fi access point (Wi-Fi AP)” exemplarily illustrated in FIG. 10. The information communication module 1115 transmits the wireless connection identification information to the user device 1001 on a default bearer of the LTE interface 1019 or a dedicated bearer of the LTE interface 1019. The wireless connection identification information is carried over the communication protocol on a reserved port number or a reserved protocol number. The information communication module 1115 transmits the wireless connection identification information to the user device 1001 based on one or more network addresses associated with the LTE interface 1019 and/or the Wi-Fi interface 1018, received from the user device 1001. One or more network addresses comprise an internet protocol (IP) address of the LTE interface 1019 and/or a media access control address of the Wi-Fi interface 1018. One of the network addresses associated with the LTE interface 1019 is assigned as a static network address to the Wi-Fi interface 1018. In an embodiment, one of the network addresses is an IP address of the Wi-Fi interface 1018 acquired from the Wi-Fi AP 1010.

In an embodiment for establishing the Wi-Fi interface 1018 between the user device 1001 and the Wi-Fi access point (Wi-Fi AP) 1010 exemplarily illustrated in FIG. 10, the information communication module 1115 receives a network address of the Wi-Fi interface 1018 assigned to the user device 1001, after transmitting the wireless connection identification information to the user device 1001, where the network address is an internet protocol (IP) address for the Wi-Fi interface 1018 acquired from the Wi-Fi AP 1010. In another embodiment, the information communication module 1115 receives a network address of the Wi-Fi interface 1018 assigned to the user device 1001 by the Wi-Fi AP 1010 and a network address of the LTE interface 1019, after transmitting the wireless connection identification information to the user device 1001, where the network address of the Wi-Fi interface 1018 is an IP address for the Wi-Fi interface 1018 acquired from the Wi-Fi AP 1010 and the network address of the LTE interface 1019 is an IP address of the LTE interface 1019.

The communication interface determination module 1116 determines the long term evolution (LTE) interface 1019 or the established Wi-Fi interface 1018 for transmitting downlink data packets from the core network 1015 to the user device 1001 and for transmitting uplink data packets from the user device 1001 to the core network 1015, based on the switching criteria. The switching criteria for transmitting the downlink data packets from the core network 1015 to the user device 1001 and for transmitting the uplink data packets from the user device 1001 to the core network 1015 is as disclosed in the detailed description of FIG. 1. The communication interface determination module 1116 dynamically selects the Wi-Fi access point (Wi-Fi AP) 1010 based on selection criteria comprising the load on the Wi-Fi AP 1010 and measurements computed by the user device 1001 on request by the base station 1014 over the communication protocol. In an embodiment, the communication interface determination module 1116 selects the communication protocol from a list comprising, for example, the user datagram protocol, the transmission control protocol, the internet protocol, etc.

The data offload module 1117 forwards the downlink data packets received from the core network 1015 on a cellular wireless network interface to the user device 1001 via the long term evolution (LTE) interface 1019 or the Wi-Fi interface 1018 determined by the communication interface determination module 1116. The cellular wireless network interface is, for example, the user plane of the S1 interface 1020 exemplarily illustrated in FIG. 10, hereinafter referred to as the “S1-U interface”. The data offload module 1117 comprises a configuration module 1118, a packet processing module 1119, and a packet forwarding module 1120. To forward the downlink data packets on the LTE interface 1019, the packet processing module 1119 maps each of the downlink data packets to a corresponding bearer on the LTE interface 1019. The packet forwarding module 1120 then forwards the mapped downlink data packets on the corresponding bearer of the LTE interface 1019. To forward the downlink data packets on the Wi-Fi interface 1018, the configuration module 1118 configures the Wi-Fi access point (Wi-Fi AP) 1010 to assign a network address associated with the LTE interface 1019 as a static internet protocol (IP) address to a media access control address of the user device 1001 on the Wi-Fi interface 1018. The packet forwarding module 1120 forwards each of the downlink data packets received from the core network 1015 to the user device 1001 via the configured Wi-Fi AP 1010 on the Wi-Fi interface 1018.

In an embodiment of forwarding the downlink data packets on the Wi-Fi interface 1018, the packet processing module 1119 encapsulates each of the downlink data packets within an outer data packet whose source internet protocol (IP) address is the IP address of the base station 1014 and whose destination IP address is an address assigned to the user device 1001 by the Wi-Fi access point (Wi-Fi AP) 1010. The packet forwarding module 1120 forwards the encapsulated downlink data packets to the user device 1001 via the Wi-Fi AP 1010 on the Wi-Fi interface 1018. In another embodiment of forwarding the downlink data packets on the Wi-Fi interface 1018, the packet processing module 1119 updates a destination IP address of each of the downlink data packets to an IP address of the Wi-Fi interface 1018 assigned to the user device 1001 by the Wi-Fi AP 1010. The packet forwarding module 1120 forwards each of the downlink data packets with the updated destination IP address to the user device 1001 via the Wi-Fi AP 1010 on the Wi-Fi interface 1018.

The data offload module 1117 also forwards the uplink data packets received from the user device 1001 via the long term evolution (LTE) interface 1019 or the Wi-Fi interface 1018 determined by the communication interface determination module 1116 to the core network 1015 on the S1-U interface. In an embodiment, the configuration module 1118 configures the Wi-Fi access point (Wi-Fi AP) 1010 to forward the uplink data packets received by the Wi-Fi AP 1010 to the base station 1014. To forward the uplink data packets on the LTE interface 1019 to the core network 1015 via the base station 1014, the packet processing module 1119 receives the uplink data packets from the user device 1001 on bearers of the LTE interface 1019 and determines bearers on the S1-U interface that correspond to the bearers of the LTE interface 1019 on which the uplink data packets are received. The packet processing module 1119 further performs a deep packet inspection of the received uplink data packets and associates traffic flow identifiers of uplink traffic flows of the received uplink data packets to the determined bearers on the S1-U interface. The packet forwarding module 1120 forwards the received uplink data packets to the core network 1015 on the determined bearers on the S1-U interface.

To forward uplink data packets on the Wi-Fi interface 1018, the packet processing module 1119 transmits packet forwarding information for the uplink data packets to be forwarded via the established Wi-Fi interface 1018 to the user device 1001 as disclosed in the detailed description of FIG. 1. The packet processing module 1119 further receives the uplink data packets from the user device 1001 based on the transmitted packet forwarding information via the Wi-Fi access point (Wi-Fi AP) 1010, performs a deep packet inspection of the received uplink data packets, and maps traffic flow identifiers of uplink traffic flows of the received uplink data packets to corresponding bearers on the S1-U interface based on an association created between the traffic flow identifiers of the uplink traffic flows of previous uplink data packets received on the long term evolution (LTE) interface 1019 and corresponding bearers on the S1-U interface. The packet forwarding module 1120 forwards the received uplink data packets to the core network 1015 on the corresponding bearers on the S1-U interface based on the mapping of the traffic flow identifiers stored in the mapping database 1121. In an embodiment, in addition to the above steps for forwarding uplink data packets on the Wi-Fi interface 1018, the packet processing module 1119 updates a source internet protocol (IP) address of each of the received uplink data packets with an IP address of the LTE interface 1019 prior to performing the deep packet inspection of each of the received uplink data packets.

In another embodiment of forwarding uplink data packets on the Wi-Fi interface 1018, the packet processing module 1119 transmits packet forwarding information for the uplink data packets to be forwarded via the established Wi-Fi interface 1018, to the user device 1001 as disclosed in the detailed description of FIG. 1, where the uplink data packets are encapsulated within outer data packets on the user device 1001 and where each of the outer data packets comprises a source network address and a destination network address as disclosed in the detailed description of FIG. 1. The packet processing module 1119 receives the encapsulated uplink data packets from the user device 1001 based on the transmitted packet forwarding information via the Wi-Fi access point (Wi-Fi AP) 1010 and extracts the uplink data packets from the encapsulated uplink data packets. The packet processing module 1119 further performs a deep packet inspection of the extracted uplink data packets and maps traffic flow identifiers of the uplink traffic flows of the extracted uplink data packets to corresponding bearers on the S1-U interface based on an association created between the traffic flow identifiers of uplink traffic flows of previous uplink data packets received on the long term evolution (LTE) interface 1019 and the corresponding bearers on the S1-U interface. The packet forwarding module 1120 forwards the extracted uplink data packets to the core network 1015 on the corresponding bearers on the S1-U interface based on the mapping of the traffic flow identifiers stored in the mapping database 1121. In an embodiment, the communication interface determination module 1116 deactivates the Wi-Fi interface 1018 when the Wi-Fi interface 1018 is not in use. In an embodiment, the packet forwarding module 1120 distributes the forwarding of the downlink data packets from the core network 1015 to the user device 1001 and the uplink data packets from the user device 1001 to the core network 1015 between the LTE interface 1019 and the Wi-Fi interface 1018 when multiple traffic flows are detected within a single bearer in the LTE network 1021 exemplarily illustrated in FIG. 10. In another embodiment (not shown), the packet processing module 1119 and the packet forwarding module 1120 are implemented in the networking processing unit 1122 for performing their respective functions as disclosed above. In this embodiment, the cellular wireless access data offload system (CWADOS) 1011 uses deep packet inspection, packet filtering or packet filter generation and packet forwarding functions implemented by the networking processing unit 1122. When the decision to select the Wi-Fi interface 1018 is made for the first time, the CWADOS 1011 performs the deep packet inspection of an uplink data packet and generates a traffic flow filter having a corresponding traffic flow identifier. A mapping of this traffic flow identifier to the corresponding bearer on the S1-U interface is stored in the base station 1014.

The mapping database 1121 can be, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the mapping database 1121 can also be locations on a file system in the volatile memory unit 1112. In another embodiment, the mapping database 1121 can be remotely accessed by the cellular wireless access data offload system (CWADOS) 1011. In another embodiment, the mapping database 1121 is configured as a cloud based database implemented in a cloud computing environment.

The volatile memory unit 1112 and the nonvolatile memory unit 1113 are used for storing programs, applications, and data. For example, the instructions defined by the information communication module 1115, the communication interface determination module 1116, and the configuration module 1118, the packet processing module 1119, and the packet forwarding module 1120 of the data offload module 1117 are stored in the volatile memory unit 1112 and the non-volatile memory unit 1113 of the cellular wireless access data offload system (CWADOS) 1011. The volatile memory unit 1112 and the non-volatile memory unit 1113 are, for example, a random access memory (RAM) or another type of dynamic storage device that stores information and instructions for execution by the signal processing unit 1111, the general purpose processing unit 1114, and the network processing unit 1122. The volatile memory unit 1112 and the non-volatile memory unit 1113 also store temporary variables and other intermediate information used during execution of the instructions by the signal processing unit 1111, the general purpose processing unit 1114, and the network processing unit 1122. The CWADOS 1011 further comprises a read only memory (ROM) or another type of static storage device that stores static information and instructions for the signal processing unit 1111, the general purpose processing unit 1114, and the network processing unit 1122.

Disclosed herein is also a non-transitory computer readable storage medium that stores computer program codes comprising instructions executable by one or more processors comprising the signal processing unit 1111, the general purpose processing unit 1114, and the network processing unit 1122 for offloading data from the long term evolution (LTE) interface 1019 to the Wi-Fi interface 1018, without impacting cellular wireless protocols of the LTE network 1021. The computer program codes comprise a first computer program code for transmitting wireless connection identification information to the user device 1001 on a bearer of the LTE 1019 using a communication protocol for establishing the Wi-Fi interface 1018 between the user device 1001 and a Wi-Fi access point (Wi-Fi AP) 1010; a second computer program code for determining the LTE interface 1019 or the established Wi-Fi interface 1018 for transmitting downlink data packets from the core network 1015 to the user device 1001 and for transmitting uplink data packets from the user device 1001 to the core network 1015, based on switching criteria; a third computer program code for forwarding the downlink data packets received from the core network 1015 on the S1-U interface to the user device 1001 via the determined LTE interface 1019 or the Wi-Fi interface 1018; and a fourth computer program code for forwarding the uplink data packets received from the user device 1001 via the determined LTE interface 1019 or the Wi-Fi interface 1018 to the core network 1015 on the S1-U interface.

The computer program codes embodied on the non-transitory computer readable storage medium disclosed herein further comprise one or more additional computer program codes for performing additional steps that may be required and contemplated for offloading data from the long term evolution (LTE) interface 1019 to the Wi-Fi interface 1018, without impacting the cellular wireless protocols of the LTE network 1021. In an embodiment, a single piece of computer program code comprising computer executable instructions performs one or more steps of the method disclosed herein for offloading data from the LTE interface 1019 to the Wi-Fi interface 1018, without impacting the cellular wireless protocols of the LTE network 1021. The processors 1111, 1114, and 1122 of the base station 1014 retrieve the computer executable instructions of the computer program codes and execute them. When the computer executable instructions are executed by the processors 1111, 1114, and 1122, the computer executable instructions cause the processors 1111, 1114, and 1122 to perform the steps of the method for offloading data from the LTE interface 1019 to the Wi-Fi interface 1018, without impacting the cellular wireless protocols of the LTE network 1021.

Consider an example that illustrates the method for offloading data from the long term evolution (LTE) interface 1019 to the Wi-Fi interface 1018 without impacting the cellular wireless protocols of the LTE network 1021 exemplarily illustrated in FIG. 10. The user device 1001 establishes one or more packet data network (PDN) connections in the LTE network 1021. The cellular wireless access data offload system (CWADOS) 1011 in the base station 1014 communicates with the user device 1001 using a data radio bearer on the LTE interface 1019. All communication between the CWADOS 1011 and the user device 1001 is performed over one of the communication protocols, for example, a user datagram protocol (UDP), a transmission control protocol (TCP), or an internet protocol (IP). A reserved UDP port number, TCP port number, or IP protocol number is used for this communication. The CWADOS 1011 requests the user device 1001 to report measurements, for example, a signal-to-interference-plus-noise ratio (SINR), a received signal strength indicator (RSSI), number of missed beacons, etc., for the Wi-Fi interface 1018.

The cellular wireless access data offload system (CWADOS) 1011 requests the user device 1001 to report the packet data network (PDN) connection internet protocol (IP) address and the Wi-Fi media access control (MAC) address of the user device 1001. The user device 1001 reports back the PDN connection IP address and its Wi-Fi MAC address. The CWADOS 1011 then requests the user device 1001 to (a) connect to a Wi-Fi access point (Wi-Fi AP) 1010; (b) assign the PDN connection IP address as a static IP address to the established Wi-Fi interface 1018 or acquire an IP address from the Wi-Fi AP 1010, and (c) confirm completion of these actions. As part of this request, the CWADOS 1011 sends the service set identifier (SSID) and the authentication password to enable the user device 1001 to establish the connection to the Wi-Fi AP 1010. The user device 1001 establishes the Wi-Fi connection, makes the static IP address assignment if an IP address was provided by the CWADOS 1011 or otherwise acquires an IP address from the Wi-Fi AP 1010, and confirms completion of the actions back to the CWADOS 1011.

In an embodiment, the cellular wireless access data offload system (CWADOS) 1011 requests the user device 1001 to connect to a Wi-Fi access point (Wi-Fi AP) 1010, acquire an internet protocol (IP) address for this connection from the Wi-Fi AP 1010, and report back the acquired IP address. As part of this request, the CWADOS 1011 sends the service set identifier (SSID) and the authentication password to enable the user device 1001 to establish the connection to the Wi-Fi AP 1010. The user device 1001 establishes the connection, acquires an IP address, and reports the Wi-Fi interface IP address back to the CWADOS 1011.

In another embodiment, the cellular wireless access data offload system (CWADOS) 1011 requests the user device 1001 to connect to a Wi-Fi access point (Wi-Fi AP) 1010, acquire an internet protocol (IP) address for this connection from the Wi-Fi AP 1010, and report back the acquired IP address and the long term evolution (LTE) packet data network (PDN) connection IP address. As part of this request, the CWADOS 1011 sends the service set identifier (SSID) and the authentication password to enable the user device 1001 to establish the connection to the Wi-Fi AP 1010. The user device 1001 establishes the connection, acquires an IP address, and reports the acquired Wi-Fi interface IP address and the LTE PDN connection IP address back to the CWADOS 1011. The CWADOS 1011 also configures the required LTE measurements in the user device 1001 via an existing base station functionality. The CWADOS 1011 also has access to the loading of the base station 1014, the Wi-Fi AP 1010, the LTE interface 1019, and the Wi-Fi interface 1018.

The method for forwarding downlink data packets from the core network 1015 to the user device 1001 is illustrated in following example. The cellular wireless access data offload system (CWADOS) 1011 in the base station 1014 requests the user device 1001 for the packet data network (PDN) connection internet protocol (IP) address and the Wi-Fi media access control (MAC) address. The user device 1001 sends the PDN connection IP address, for example, 122.202.25.73, and the Wi-Fi MAC address, for example, 01:02:03:04:05:06, to the CWADOS 1011. The CWADOS 1011 requests the user device 1001 to connect to the Wi-Fi access point (Wi-Fi AP) 1010 exemplarily illustrated in FIG. 10, assign the PDN connection IP address as a static IP address to the established Wi-Fi connection, and confirm completion of the actions. The user device 1001 assigns the PDN connection IP address as the static IP address to the established Wi-Fi connection and confirms completion of the actions. The CWADOS 1011 configures the PDN connection IP address as the static IP address for the Wi-Fi MAC address in the Wi-Fi AP 1010. The base station 1014 receives a downlink data packet with the source IP address, for example, 202. 101.55.22 on the data network side, and the destination IP address, for example, 122.202.25.73. The CWADOS 1011 forwards the received downlink data packet to the Wi-Fi AP 1010. The Wi-Fi AP 1010 determines that the destination IP address of the downlink data packet is a static IP address assigned to the user device 1001 with the Wi-Fi MAC address and forwards the downlink data packet to the static IP address. The Wi-Fi module 1008 in the user device 1001 receives the downlink data packet as the downlink data packet is addressed with the Wi-Fi MAC address and forwards the downlink data packet to the application 1002 on the user device 1001 via the wireless local area network (WLAN) driver 1006 and the operating system (OS) networking stack 1004 exemplarily illustrated in FIG. 10.

An embodiment of the method for forwarding downlink data packets from the core network 1015 to the user device 1001 is illustrated in the following example. The cellular wireless access data offload system (CWADOS) 1011 in the base station 1014 requests the user device 1001 for the packet data network (PDN) connection internet protocol (IP) address. The user device 1001 sends the PDN connection IP address, for example, 122.202.25.73, to the CWADOS 1011. The CWADOS 1011 requests the user device 1001 to connect to the Wi-Fi access point (Wi-Fi AP) 1010, acquire an IP address, and report back the acquired IP address. The user device 1001 connects to the Wi-Fi AP 1010, acquires the IP address, for example, 192.168.3.3, that is, the Wi-Fi interface IP address, and reports the IP address back to the CWADOS 1011. The base station 1014 receives a downlink data packet with the source IP address, for example, 202. 101.55.22 on the data network side, and the destination IP address, for example, 122.202.25.73. The CWADOS 1011 encapsulates the downlink data packet, that is, the inner IP data packet within an outer IP data packet. For the outer IP data packet, the source IP address is the IP address of the base station 1014, for example, 192.168.3.2, and the destination address is the Wi-Fi interface IP address on the user device 1001, for example, 192.168.3.3. The CWADOS 1011 forwards the outer IP data packet to the Wi-Fi AP 1010. The Wi-Fi AP 1010 knows that the Wi-Fi AP 1010 assigned the destination IP address of the outer IP data packet to the user device 1001 and therefore forwards the outer IP data packet to the user device 1001. The Wi-Fi module 1008 in the user device 1001 receives the outer IP data packet with the downlink data packet and forwards the outer IP data packet via the wireless local area network (WLAN) driver 1006 to the operating system (OS) networking stack 1004 of the user device 1001. The OS networking stack 1004 extracts the inner IP data packet with the source IP address, for example, 202. 101.55.22, and the destination IP address, for example, 122.202.25.73, encapsulated in the outer IP data packet, and forwards the inner IP data packet to the application 1002 of the user device 1001.

Another embodiment of the method for forwarding downlink data packets from the core network 1015 to the user device 1001 is illustrated in the following example. The cellular wireless access data offload system (CWADOS) 1011 in the base station 1014 requests the user device 1001 to connect to the Wi-Fi access point (Wi-Fi AP) 1010, acquire an internet protocol (IP) address, and report back the acquired IP address and the packet data network (PDN) connection internet protocol (IP) address. The user device 1001 connects to the Wi-Fi AP 1010, acquires the IP address, that is, the Wi-Fi interface IP address, for example, 192.168.3.3, and reports the acquired IP address and the PDN connection IP address, for example, 122.202.25.73 back to the CWADOS 1011. The base station 1014 receives a downlink data packet with the source IP address as the data network side IP address, for example, 202 101.55.22, and the destination IP address as the PDN connection IP address, for example, 122.202.25.73. The CWADOS 1011 updates the destination IP address to the Wi-Fi interface IP address on the user device 1001. The CWADOS 1011 forwards the downlink data packet to the Wi-Fi AP 1010. The Wi-Fi AP 1010 knows that the Wi-Fi AP 1010 assigned the destination IP address of the downlink data packet, for example, 192.168.3.3, to the user device 1001 and therefore forwards the downlink data packet to the user device 1001. The Wi-Fi module 1008 of the user device 1001 receives the downlink data packet and forwards the received downlink data packet via the wireless local area network (WLAN) driver 1006 to the operating system (OS) networking stack 1004 of the user device 1001. The OS networking stack 1004 updates the destination IP address to the PDN connection IP address and forwards the received downlink data packet to the application 1002 of the user device 1001.

The method for forwarding uplink data packets from the user device 1001 to the core network 1015 is illustrated in the following example. The cellular wireless access data offload system (CWADOS) 1011 in the base station 1014 receives an uplink data packet on a bearer of the long term evolution (LTE) interface 1019. The CWADOS 1011 determines the bearer on the S1-U interface, for example, S1-U bearer x, that corresponds to the bearer of the LTE interface 1019 on which the uplink data packet was received, and forwards the uplink data packet on the determined bearer, that is, the S1-U bearer x. The uplink data packet has the source internet protocol (IP) address, for example, 122.202.25.73, the source user datagram protocol (UDP) port number, for example, 1234, the destination IP address, for example, 202. 101.55.22, and the destination UDP port number, for example, 4321. The CWADOS 1011 derives a traffic flow identifier, for example, [122.202.25.73, 1234, 202. 101.55.22, 4321] from the uplink data packet. The CWADOS 1011 associates the traffic flow identifier to the S1-U bearer x. The CWADOS 1011 requests the user device 1001 to transmit uplink data packets belonging to uplink traffic flow identified by the traffic flow identifier on the Wi-Fi interface 1018. The operating system (OS) networking stack 1004 on the user device 1001 receives an uplink data packet for transmission from the application 1002 on the user device 1001. The uplink data packet has the source IP address, for example, 122.202.25.73, the source UDP port number, for example, 1234, the destination IP address, for example, 202. 101.55.22, and the destination UDP port number, for example, 4321. The uplink data packet belongs to the uplink traffic flow identified by the traffic flow identifier, for example, [122.202.25.73, 1234, 202. 101.55.22, 4321]. The OS networking stack 1004 forwards the uplink data packet to the wireless local area network (WLAN) driver 1006 of the user device 1001 as this uplink traffic flow was directed to the Wi-Fi interface 1018 by the CWADOS 1011. The WLAN driver 1006 forwards the uplink data packet via the Wi-Fi module 1008 on the user device 1001 and via the Wi-Fi access point (Wi-Fi AP) 1010 to the base station 1014, from where the CWADOS 1011 receives the uplink data packet. The CWADOS 1011 determines that the uplink data packet belongs to the uplink traffic flow identified by the traffic flow identifier [122.202.25.73, 1234, 202. 101.55.22, 4321]. From the association created when the uplink data packet was received on the LTE interface 1019, the CWADOS 1011 knows that the uplink data packet has to be forwarded on the S1-U bearer x and therefore forwards the uplink data packet on the S1-U bearer x.

An embodiment of the method for forwarding uplink data packets from the user device 1001 to the core network 1015 is illustrated in the following example. The cellular wireless access data offload system (CWADOS) 1011 in the base station 1014 receives an uplink data packet on a bearer of the long term evolution (LTE) interface 1019. The CWADOS 1011 determines the bearer on the S1-U interface, for example, S1-U bearer x, that corresponds to the bearer of the LTE interface 1019 on which the uplink data packet was received, and forwards the uplink data packet on the determined bearer, that is, the S1-U bearer x. The uplink data packet has the source internet protocol (IP) address, for example, 122.202.25.73, the source user datagram protocol (UDP) port number, for example, 1234, the destination IP address, for example, 202 101.55.22, and the destination UDP port number, for example, 4321. The CWADOS 1011 derives a traffic flow identifier, for example, [122.202.25.73, 1234, 202 101.55.22, 4321] from the uplink data packet. The CWADOS 1011 associates the traffic flow identifier to the S1-U bearer x. The CWADOS 1011 requests the user device 1001 to transmit uplink data packets belonging to the uplink traffic flow identified by the traffic flow identifier [122.202.25.73, 1234, 202 101.55.22, 4321] on the Wi-Fi interface 1018. The request also comprises the IP address of the base station 1014. The operating system (OS) networking stack 1004 on the user device 1001 receives an uplink data packet for transmission from the application 1002 on the user device 1001. The uplink data packet has the source IP address, for example, 122.202.25.73, the source UDP port number, for example, 1234, the destination IP address, for example, 202 101.55.22, and the destination UDP port number, for example, 4321. The uplink data packet belongs to the uplink traffic flow identified by the traffic flow identifier [122.202.25.73, 1234, 202 101.55.22, 4321]. The OS networking stack 1004 encapsulates the uplink data packet, that is, the inner IP data packet within an outer IP data packet. For the outer IP data packet, the destination IP address is the IP address of the base station 1014, for example, 192.168.3.2, and the source IP address is the Wi-Fi interface IP address on the user device 1001, for example, 192.168.3.3. The OS networking stack 1004 forwards the outer IP data packet to the wireless local area network (WLAN) driver 1006 of the user device 1001 since the uplink traffic flow was directed to the Wi-Fi interface 1018 by the CWADOS 1011. The WLAN driver 1006 forwards the outer IP data packet via the Wi-Fi module 1008 on the user device 1001 and via the Wi-Fi access point (Wi-Fi AP) 1010 to the base station 1014, from where the CWADOS 1011 receives the outer IP data packet. The CWADOS 1011 extracts the inner IP data packet from the received outer IP data packet. The CWADOS 1011 determines that the inner IP data packet belongs to the uplink traffic flow identified by the traffic flow identifier [122.202.25.73, 1234, 202.101.55.22, 4321]. From the association created when the uplink data packet was received on the LTE interface 1019, the CWADOS 1011 knows that this inner IP data packet has to be forwarded on the S1-U bearer x.

Another embodiment of the method for forwarding uplink data packets from the user device 1001 to the core network 1015 is illustrated in the following example. The cellular wireless access data offload system (CWADOS) 1011 in the base station 1014 receives an uplink data packet on a bearer of the long term evolution (LTE) interface 1019. The CWADOS 1011 determines the bearer on the S1-U interface, for example, S1-U bearer x, that corresponds to the bearer of the LTE interface 1019 on which the uplink data packet was received, and forwards the uplink data packet on the determined bearer, that is, the S1-U bearer x. The uplink data packet has the source internet protocol (IP) address, for example, 122.202.25.73, the source user datagram protocol (UDP) port number, for example, 1234, the destination IP address, for example, 202. 101.55.22, and the destination UDP port, for example, 4321. The CWADOS 1011 derives the traffic flow identifier, for example, [122.202.25.73, 1234, 202.101.55.22, 4321], from the uplink data packet. The CWADOS 1011 maps the traffic flow identifier to the S1-U bearer x. The CWADOS 1011 requests the user device 1001 to transmit uplink data packets belonging to uplink traffic flow identified by the traffic flow identifier [122.202.25.73, 1234, 202.101.55.22, 4321] on the Wi-Fi interface 1018. The operating system (OS) networking stack 1004 on the user device 1001 receives an uplink data packet for transmission from the application 1002 on the user device 1001. The uplink data packet has the source IP address, for example, 122.202.25.73, the source UDP port number, for example, 1234, the destination IP address, for example, 202 101.55.22, and the destination UDP port number, for example, 4321. The uplink data packet belongs to the uplink traffic flow identified by the traffic flow identifier [122.202.25.73, 1234, 202.101.55.22, 4321]. The OS networking stack 1004 changes or updates the source IP address to the Wi-Fi interface IP address on the user device 1001, for example, 192.168.3.3, and forwards the uplink data packet to the wireless local area network (WLAN) driver 1006 since the source IP address belongs to the Wi-Fi interface 1018. The WLAN driver 1006 forwards the uplink data packet via the Wi-Fi module 1008 on the user device 1001, and via the Wi-Fi access point (Wi-Fi AP) 1010 to the base station 1014, from where the CWADOS 1011 receives the uplink data packet. The CWADOS 1011 changes the source IP address to the PDN connection IP address, for example, 122.202.25.73, and determines that the uplink data packet belongs to the traffic flow identified by the traffic flow identifier [122.202.25.73, 1234, 202.101.55.22, 4321]. From the association created when the uplink data packet was received on the LTE interface 1019, the CWADOS 1011 knows that this uplink data packet has to be forwarded on the S1-U bearer x.

The method disclosed herein, employing the cellular wireless access data offload system (CWADOS) 1011, technically affects the functionality of hardware of the base station 1014 and contributes to the data offloading process carried on outside a generic computer. The base station 1014 transmits data packets to long term evolution (LTE) users in both directions. The CWADOS 1011 allows offload of data packets to the Wi-Fi interface 1018, thereby allowing the user device 1001 to transmit and receive the offloaded data packets on the Wi-Fi interface 1018. The CWADOS 1011 allows the user device 1001 to establish an internet connection with an enhanced throughput and with a better experience. Therefore, the CWADOS 1011 improves the process of transmitting data packets to and receiving data packets from the user device 1001 using the communications system 1000 exemplarily illustrated in FIG. 10, of which the general purpose processing unit 1114 in the base station 1014 is one component among other components. In an embodiment, the hardware of the network processing unit 1122 of the base station 1014 is enhanced to perform deep packet inspection of the uplink data packets and forwards the downlink data packets to the user device 1001 and the uplink data packets to the core network 1015.

The quality of communication on the long term evolution (LTE) interface 1019 is constrained by the number of user devices 1001 on the LTE interface 1019. The throughput delivered to the user device 1001 is reduced when the LTE interface 1019 is overloaded. By offloading the data to the Wi-Fi interface 1018 from the LTE interface 1019, the cellular wireless access data offload system (CWADOS) 1011 in the base station 1014 caters to an increased number of user devices 1001 and offers an increased aggregated throughput to the user devices 1001. Furthermore, when the network processing unit 1122 implements the deep packet inspection and packet forwarding functions, the general purpose processing unit 1114 is freed up from performing these tasks in software that allows the general purpose processing unit 1114 to handle more users and a greater throughput. Therefore, due to the division of tasks between the general purpose processing unit 1114 and the network processing unit 1122, there is an increase in the efficiency of the base station 1014.

It will be readily apparent in different embodiments that the various methods, algorithms, and computer programs disclosed herein are implemented on computer readable storage media appropriately programmed for the cellular wireless access data offload system (CWADOS) 1011 exemplarily illustrated in FIGS. 10-11. As used herein, “computer readable storage media” refers to non-transitory computer readable storage media that participate in providing data, for example, instructions that are read by a computer, a processor or a similar device. The “computer-readable storage media” further refers to a single medium or multiple media, for example, a centralized database, a distributed database, and/or associated caches and servers that store one or more sets of instructions that are read by a computer, a processor or a similar device. The “computer-readable storage media” further refers to any medium capable of storing or encoding a set of instructions for execution by a computer, a processor or a similar device and that causes a computer, a processor or a similar device to perform any one or more of the methods disclosed herein. Non-transitory computer readable storage media comprise all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in a number of manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C#, a stack oriented programming language, Python®, etc. In an embodiment, the computer program codes or software programs are stored on or in one or more mediums as object code. In another embodiment, various aspects of the method and the communications system 1000 disclosed herein and exemplarily illustrated in FIG. 10, are implemented as programmed elements, or non-programmed elements, or any suitable combination thereof. The non-transitory computer readable storage medium disclosed herein comprises one or more computer program codes for implementing the processes of various embodiments.

Where databases are described such as the mapping database 1121, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the communications system 1000, the databases are integrated to communicate with each other for enabling simultaneous updates of data linked across the databases, when there are any updates to the data in one of the databases.

The method and the communications system 1000 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The method and the communications system 1000 disclosed herein are not limited to a particular computer system platform, processor, operating system, or network. In an embodiment, one or more aspects of the method and the communications system 1000 disclosed herein are distributed among one or more computer systems, for example, servers configured to provide one or more services to one or more client computers, or to perform a complete task in a distributed system. For example, one or more aspects of the method and the communications system 1000 disclosed herein are performed on a client-server system that comprises components distributed among one or more server systems that perform multiple functions according to various embodiments. These components comprise, for example, executable, intermediate, or interpreted code, which communicate over a network using a communication protocol. The method and the communications system 1000 disclosed herein are not limited to be executable on any particular system or group of systems, and are not limited to any particular distributed architecture, network, or communication protocol.

The foregoing examples have been provided merely for the purpose of explanation and are in no way to be construed as limiting of the method and the communications system 1000 disclosed herein. While the method and the communications system 1000 have been described with reference to various embodiments, it is understood that the words, which have been used herein, are words of description and illustration, rather than words of limitation. Further, although the method and the communications system 1000 have been described herein with reference to particular means, materials, and embodiments, the method and the communications system 1000 are not intended to be limited to the particulars disclosed herein; rather, the method and the communications system 1000 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the communications system 1000 disclosed herein in their aspects.

We claim:

1. A method for offloading data from a first cellular wireless communication interface to a second wireless communication interface without impacting cellular wireless protocols of a cellular wireless communication network, the method employing a cellular wireless access data offload system implemented in a base station of the cellular wireless communication network, the method comprising:
transmitting wireless connection identification information to a user device by the cellular wireless access data offload system, on a bearer of the first cellular wireless communication interface using a communication protocol for establishing the second wireless communication interface between the user device and a wireless access point;
determining one of the first cellular wireless communication interface and the established second wireless communication interface by the cellular wireless access data offload system for transmitting downlink data packets from a core network of the cellular wireless communication network to the user device and for transmitting uplink data packets from the user device to the core network, based on switching criteria;
forwarding the downlink data packets received from the core network on a cellular wireless network interface to the user device by the cellular wireless access data offload system via the determined one of the first cellular wireless communication interface and the second wireless communication interface; and
forwarding the uplink data packets received from the user device via the determined one of the first cellular wireless communication interface and the second wireless communication interface to the core network on the cellular wireless network interface by the cellular wireless access data offload system.

2. The method of claim 1, wherein the wireless connection identification information is transmitted to the user device by the cellular wireless access data offload system based on one or more network addresses associated with one or more of the first cellular wireless communication interface and the second wireless communication interface, received from the user device by the cellular wireless access data offload system.

3. The method of claim 2, wherein the one or more network addresses comprise one or more of an internet protocol address of the first cellular wireless communication interface and a media access control address of the second wireless communication interface.

4. The method of claim 3, wherein one of the one or more network addresses associated with the first cellular wireless communication interface is assigned as a static network address to the second wireless communication interface.

5. The method of claim 2, wherein one of the one or more network addresses is an internet protocol address of the second wireless communication interface acquired from the wireless access point.

6. The method of claim 1, further comprising receiving, by the cellular wireless access data offload system, a network address of the second wireless communication interface assigned to the user device by the wireless access point, after transmitting the wireless connection identification information to the user device.

7. The method of claim 6, wherein the network address of the second wireless communication interface is an internet protocol address for the second wireless communication interface acquired from the wireless access point.

8. The method of claim 1, further comprising receiving, by the cellular wireless access data offload system, a network address of the second wireless communication interface assigned to the user device by the wireless access point and a network address of the first cellular wireless communication interface, after transmitting the wireless connection identification information to the user device.

9. The method of claim 8, wherein the network address of the second wireless communication interface is an internet protocol address for the second wireless communication interface acquired from the wireless access point.

10. The method of claim 8, wherein the network address of the first cellular wireless communication interface is an internet protocol address of the first cellular wireless communication interface.

11. The method of claim 1, wherein the switching criteria for transmitting the downlink data packets from the core network to the user device and for transmitting the uplink data packets from the user device to the core network comprise one or more of loading of the base station, a load on the second wireless communication interface, quality of service requirements of bearers of the first cellular wireless communication interface, channel conditions of the first cellular wireless communication interface, channel conditions of the second wireless communication interface, and a control policy of the cellular wireless communication network.

12. The method of claim 1, wherein the forwarding of the downlink data packets from the core network to the user device by the cellular wireless access data offload system via the second wireless communication interface comprises:
configuring the wireless access point to assign a network address associated with the first cellular wireless communication interface as a static internet protocol address to a media access control address of the user device on the second wireless communication interface; and
forwarding each of the downlink data packets received from the core network to the user device via the configured wireless access point on the second wireless communication interface.

13. The method of claim 1, wherein the forwarding of the downlink data packets from the core network to the user device by the cellular wireless access data offload system via the second wireless communication interface comprises:
encapsulating each of the downlink data packets within an outer data packet whose source internet protocol address is an internet protocol address of the base station and whose destination internet protocol address is an address assigned to the user device by the wireless access point; and
forwarding the encapsulated each of the downlink data packets to the user device via the wireless access point on the second wireless communication interface.

14. The method of claim 1, wherein the forwarding of the downlink data packets from the core network to the user device by the cellular wireless access data offload system via the second wireless communication interface comprises:
updating a destination internet protocol address of each of the downlink data packets to an internet protocol address of the second wireless communication interface assigned to the user device by the wireless access point; and
forwarding the each of the downlink data packets with the updated destination internet protocol address to the user device via the wireless access point on the second wireless communication interface.

15. The method of claim 1, wherein the forwarding of the uplink data packets received from the user device via the first cellular wireless communication interface to the core network on the cellular wireless network interface by the cellular wireless access data offload system comprises:
receiving the uplink data packets from the user device on bearers of the first cellular wireless communication interface;
determining bearers on the cellular wireless network interface that correspond to the bearers of the first cellular wireless communication interface on which the uplink data packets are received;
performing a deep packet inspection of the received uplink data packets and associating traffic flow identifiers of uplink traffic flows of the received uplink data packets to the determined bearers on the cellular wireless network interface by the cellular wireless access data offload system; and
forwarding the received uplink data packets to the core network on the determined bearers on the cellular wireless network interface.

16. The method of claim 1, wherein the forwarding of the uplink data packets received from the user device via the established second wireless communication interface to the core network on the cellular wireless network interface by the cellular wireless access data offload system comprises:
transmitting packet forwarding information for the uplink data packets to be forwarded via the established second wireless communication interface, to the user device, wherein the packet forwarding information comprises traffic flow identifiers for uplink traffic flows and a corresponding quality of service class for each of the uplink traffic flows;
receiving the uplink data packets from the user device based on the transmitted packet forwarding information via the wireless access point;
performing a deep packet inspection of the received uplink data packets and mapping traffic flow identifiers of uplink traffic flows of the received uplink data packets to corresponding bearers on the cellular wireless network interface based on an association created between the traffic flow identifiers of the uplink traffic flows of previous uplink data packets received on the first cellular wireless communication interface and corresponding bearers on the cellular wireless network interface; and
forwarding the received uplink data packets to the core network on the corresponding bearers on the cellular wireless network interface based on the mapping of the traffic flow identifiers.

17. The method of claim 16, further comprising updating a source internet protocol address of each of the received uplink data packets with an internet protocol address of the first cellular wireless communication interface by the cellular wireless access data offload system prior to performing the deep packet inspection of the each of the received uplink data packets.

18. The method of claim 1, wherein the forwarding of the uplink data packets received from the user device via the established second wireless communication interface to the core network on the cellular wireless network interface by the cellular wireless access data offload system comprises:
transmitting packet forwarding information for the uplink data packets to be forwarded via the established second wireless communication interface, to the user device, wherein the packet forwarding information comprises traffic flow identifiers for uplink traffic flows and a corresponding quality of service class for each of the uplink traffic flows, and wherein the uplink data packets are encapsulated within outer data packets on the user device, each of the outer data packets comprising a source network address and a destination network address;
receiving the encapsulated uplink data packets from the user device based on the transmitted packet forwarding information via the wireless access point;
extracting the uplink data packets from the encapsulated uplink data packets;
performing a deep packet inspection of the extracted uplink data packets and mapping traffic flow identifiers of the uplink traffic flows of the extracted uplink data packets to corresponding bearers on the cellular wireless network interface based on an association created between the traffic flow identifiers of uplink traffic flows of previous uplink data packets received on the first cellular wireless communication interface and the corresponding bearers on the cellular wireless network interface; and
forwarding the extracted uplink data packets to the core network on the corresponding bearers on the cellular wireless network interface based on the mapping of the traffic flow identifiers.

19. The method of claim 18, wherein the packet forwarding information further comprises an internet protocol address of the base station.

20. The method of claim 18, wherein the source network address is an internet protocol address assigned to the user device by the wireless access point, and wherein the destination network address is an internet protocol address of the base station.

21. The method of claim 1, further comprising configuring the wireless access point to forward the uplink data packets received by the wireless access point to the base station by the cellular wireless access data offload system.

22. The method of claim 1, wherein the wireless connection identification information comprises a unique identifier of the wireless access point and authentication information required for the user device to establish a connection with the wireless access point.

23. The method of claim 1, wherein the wireless connection identification information is transmitted by the cellular wireless access data offload system to the user device on one of a default bearer of the first cellular wireless communication interface and a dedicated bearer of the first cellular wireless communication interface and carried over the communication protocol on one of a reserved port number and a reserved protocol number.

24. The method of claim 1, further comprising dynamically selecting the wireless access point by the cellular wireless access data offload system based on selection criteria comprising a load on the wireless access point and measurements computed by the user device on request by the base station over the communication protocol.

25. The method of claim 24, wherein the measurements comprise a received signal strength indicator for the second wireless communication interface, number of missed beacons, a signal-to-interference-plus-noise ratio, and a frame error rate on the second wireless communication interface.

26. The method of claim 1, wherein the wireless access point is positioned at one of a first location within the base station, a second location adjacent to the base station, and a third location away from the base station.

27. The method of claim 1, wherein an operating system of the user device is configured to allow the second wireless communication interface to be used as a tunnel for carrying information that is carried on the first cellular wireless communication interface.

28. The method of claim 1, wherein an operating system of the user device is configured to update a source network address and a destination network address of each of the downlink data packets and each of the uplink data packets.

29. The method of claim 1, further comprising distributing the forwarding of the downlink data packets from the core network to the user device and the uplink data packets from the user device to the core network between the first cellular wireless communication interface and the second wireless communication interface by the cellular wireless access data offload system when multiple traffic flows are detected within a single bearer in the cellular wireless communication network.

30. The method of claim 1, further comprising deactivating the second wireless communication interface by the cellular wireless access data offload system when the second wireless communication interface is not in use.

31. The method of claim 1, wherein the first cellular wireless communication interface is a long term evolution interface.

32. The method of claim 1, wherein the second wireless communication interface is a wireless local area network interface.

33. The method of claim 1, wherein the communication protocol is selected from a list comprising a user datagram protocol, a transmission control protocol, and an internet protocol.

34. The method of claim 1, wherein the base station of the cellular wireless communication network is an evolved node B.

35. The method of claim 1, wherein the bearer of the first cellular wireless communication interface is a data radio bearer.

36. A base station for offloading data from a first cellular wireless communication interface to a second wireless communication interface without impacting cellular wireless protocols of a cellular wireless communication network, the base station comprising:
one or more antennas;
a radio frequency unit operably coupled to the one or more antennas, the radio frequency unit configured to transmit and receive radio frequency electromagnetic waves via the one or more antennas;
at least one processor communicatively coupled to the radio frequency unit, the at least one processor configured to execute computer program instructions defined by a cellular wireless access data offload system;
the cellular wireless access data offload system executable by the at least one processor, the cellular wireless access data offload system comprising:
an information communication module configured to transmit wireless connection identification information to a user device on a bearer of the first cellular wireless communication interface using a communication protocol for establishing the second wireless communication interface between the user device and a wireless access point;
a communication interface determination module configured to determine one of the first cellular wireless communication interface and the established second wireless communication interface for transmitting downlink data packets from a core network of the cellular wireless communication network to the user device and for transmitting uplink data packets from the user device to the core network, based on switching criteria;
a data offload module configured to forward the downlink data packets received from the core network on a cellular wireless network interface to the user device via the determined one of the first cellular wireless communication interface and the second wireless communication interface; and
the data offload module further configured to forward the uplink data packets received from the user device via the determined one of the first cellular wireless communication interface and the second wireless communication interface to the core network on the cellular wireless network interface; and
a non-transitory computer readable storage medium communicatively coupled to the at least one processor and configured to store the computer program instructions defined by the cellular wireless access data offload system.

37. The base station of claim 36, wherein the information communication module is configured to transmit the wireless connection identification information to the user device based on one or more network addresses associated with one or more of the first cellular wireless communication interface and the second wireless communication interface, received from the user device.

38. The base station of claim 37, wherein the one or more network addresses comprise one or more of an internet protocol address of the first cellular wireless communication interface and a media access control address of the second wireless communication interface, and wherein one of the one or more network addresses associated with the first cellular wireless communication interface is assigned as a static network address to the second wireless communication interface.

39. The base station of claim 37, wherein one of the one or more network addresses is an internet protocol address of the second wireless communication interface acquired from the wireless access point.

40. The base station of claim 36, wherein the information communication module is further configured to receive a network address of the second wireless communication interface assigned to the user device by the wireless access point, after transmitting the wireless connection identification information to the user device, wherein the network address of the second wireless communication interface is an internet protocol address for the second wireless communication interface acquired from the wireless access point.

41. The base station of claim 36, wherein the information communication module is further configured to receive a network address of the second wireless communication interface assigned to the user device by the wireless access point and a network address of the first cellular wireless communication interface, after transmitting the wireless connection identification information to the user device, and wherein the network address of the second wireless communication interface is an internet protocol address for the second wireless communication interface acquired from the wireless access point, and wherein the network address of the first cellular wireless communication interface is an internet protocol address of the first cellular wireless communication interface.

42. The base station of claim 36, wherein the switching criteria for transmitting the downlink data packets from the core network to the user device and for transmitting the uplink data packets from the user device to the core network comprise one or more of loading of the base station, a load on the second wireless communication interface, quality of service requirements of bearers of the first cellular wireless communication interface, channel conditions of the first cellular wireless communication interface, channel conditions of the second wireless communication interface, and a control policy of the cellular wireless communication network.

43. The base station of claim 36, wherein the data offload module comprises:
a configuration module configured to configure the wireless access point to assign a network address associated with the first cellular wireless communication interface as a static internet protocol address to a media access control address of the user device on the second wireless communication interface; and
a packet forwarding module configured to forward each of the downlink data packets received from the core network to the user device via the configured wireless access point on the second wireless communication interface.

44. The base station of claim 36, wherein the data offload module comprises:
a packet processing module configured to encapsulate each of the downlink data packets within an outer data packet whose source internet protocol address is an internet protocol address of the base station and whose destination internet protocol address is an address assigned to the user device by the wireless access point; and
a packet forwarding module configured to forward the encapsulated each of the downlink data packets to the user device via the wireless access point on the second wireless communication interface.

45. The base station of claim 36, wherein the data offload module comprises:
a packet processing module configured to update a destination internet protocol address of each of the downlink data packets to an internet protocol address of the second wireless communication interface assigned to the user device by the wireless access point; and
a packet forwarding module configured to forward the each of the downlink data packets with the updated destination internet protocol address to the user device via the wireless access point on the second wireless communication interface.

46. The base station of claim 36, wherein the data offload module comprises:
a packet processing module configured to receive the uplink data packets from the user device on bearers of the first cellular wireless communication interface;
the packet processing module further configured to determining bearers on the cellular wireless network interface that correspond to the bearers of the first cellular wireless communication interface on which the uplink data packets are received;
the packet processing module further configured to perform a deep packet inspection of the received uplink data packets and associate traffic flow identifiers of uplink traffic flows of the received uplink data packets to the determined bearers on the cellular wireless network interface; and
a packet forwarding module configured to forward the received uplink data packets to the core network on the determined bearers on the cellular wireless network interface.

47. The base station of claim 36, wherein the data offload module comprises:
a packet processing module configured to transmit packet forwarding information for the uplink data packets to be forwarded via the established second wireless communication interface, to the user device, wherein the packet forwarding information comprises traffic flow identifiers for uplink traffic flows and a corresponding quality of service class for each of the uplink traffic flows;
the packet processing module further configured to receive the uplink data packets from the user device based on the transmitted packet forwarding information via the wireless access point;
the packet processing module further configured to perform a deep packet inspection of the received uplink data packets and map traffic flow identifiers of uplink traffic flows of the received uplink data packets to corresponding bearers on the cellular wireless network interface based on an association created between the traffic flow identifiers of the uplink traffic flows of previous uplink data packets received on the first cellular wireless communication interface and corresponding bearers on the cellular wireless network interface; and
a packet forwarding module configured to forward the received uplink data packets to the core network on the corresponding bearers on the cellular wireless network interface based on the mapping of the traffic flow identifiers.

48. The base station of claim 47, wherein the packet processing module is further configured to update a source internet protocol address of each of the received uplink data packets with an internet protocol address of the first cellular wireless communication interface prior to performing the deep packet inspection of the each of the received uplink data packets.

49. The base station of claim 36, wherein the data offload module comprises:
a packet processing module configured to transmit packet forwarding information for the uplink data packets to be forwarded via the established second wireless communication interface, to the user device, wherein the packet forwarding information comprises traffic flow identifiers for uplink traffic flows and a corresponding quality of service class for each of the uplink traffic flows, and wherein the uplink data packets are encapsulated within outer data packets on the user device, each of the outer data packets comprising a source network address and a destination network address, and wherein the source network address is an internet protocol address assigned to the user device by the wireless access point, and wherein the destination network address is an internet protocol address of the base station;
the packet processing module further configured to receive the encapsulated uplink data packets from the user device based on the transmitted packet forwarding information via the wireless access point;
the packet processing module further configured to extract the uplink data packets from the encapsulated uplink data packets;
the packet processing module further configured to perform a deep packet inspection of the extracted uplink data packets and map traffic flow identifiers of the uplink traffic flows of the extracted uplink data packets to corresponding bearers on the cellular wireless network interface based on an association created between the traffic flow identifiers of uplink traffic flows of previous uplink data packets received on the first cellular wireless communication interface and the corresponding bearers on the cellular wireless network interface; and
a packet forwarding module configured to forward the extracted uplink data packets to the core network on the corresponding bearers on the cellular wireless network interface based on the mapping of the traffic flow identifiers.

50. The base station of claim 36, wherein the data offload module comprises a configuration module configured to configure the wireless access point to forward the uplink data packets received by the wireless access point to the base station.

51. The base station of claim 36, wherein the wireless connection identification information comprises a unique identifier of the wireless access point and authentication information required for the user device to establish a connection with the wireless access point.

52. The base station of claim 36, wherein the information communication module is configured to transmit the wireless connection identification information to the user device on one of a default bearer of the first cellular wireless communication interface and a dedicated bearer of the first cellular wireless communication interface, and wherein the wireless connection identification information is carried over the communication protocol on one of a reserved port number and a reserved protocol number.

53. The base station of claim 36, wherein the communication interface determination module is further configured to dynamically select the wireless access point based on selection criteria comprising a load on the wireless access point and measurements computed by the user device on request by the base station over the communication protocol, wherein the measurements comprise a received signal strength indicator for the second wireless communication interface, number of missed beacons, a signal-to-interference-plus-noise ratio, and a frame error rate on the second wireless communication interface.

54. The base station of claim 36, wherein the data offload module comprises a packet forwarding module configured to distribute the forwarding of the downlink data packets from the core network to the user device and the uplink data packets from the user device to the core network between the first cellular wireless communication interface and the second wireless communication interface when multiple traffic flows are detected within a single bearer in the cellular wireless communication network.

55. The base station of claim 36, wherein the communication interface determination module is further configured to deactivate the second wireless communication interface when the second wireless communication interface is not in use.

56. A non-transitory computer readable storage medium having embodied thereon, computer program codes comprising instructions executable by at least one processor for offloading data from a first cellular wireless communication interface to a second wireless communication interface without impacting cellular wireless protocols of a cellular wireless communication network, the computer program codes comprising:
a first computer program code for transmitting wireless connection identification information to a user device on a bearer of the first cellular wireless communication interface using a communication protocol for establishing the second wireless communication interface between the user device and a wireless access point;
a second computer program code for determining one of the first cellular wireless communication interface and the established second wireless communication interface for transmitting downlink data packets from a core network of the cellular wireless communication network to the user device and for transmitting uplink data packets from the user device to the core network, based on switching criteria;
a third computer program code for forwarding the downlink data packets received from the core network on a cellular wireless network interface to the user device via the determined one of the first cellular wireless communication interface and the second wireless communication interface; and
a fourth computer program code for forwarding the uplink data packets received from the user device via the determined one of the first cellular wireless communication interface and the second wireless communication interface to the core network on the cellular wireless network interface.
